(19) United States
(12) Patent Application Publication
(10) Pub. No.: US 2006/0176846 A1
(43) Pub. Date: Aug. 10, 2006

(54) Communications apparatus, communications method, program, and computer-readable storage medium storing program

(75) Inventors: Hirosuke Miki, Tenri-shi (JP); Yoshihiro Ohtani, Soraku-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/325,574

(22) Filed: Jan. 5, 2006

(30) Foreign Application Priority Data
Jan. 7, 2005 (JP) 2005-003222
Dec. 23, 2005 (JP) 2005-371180

(51) Int. Cl. H04Q 7/00; H04J 3/06; H04J 3/16; H04Q 7/24; H04J 3/22

(52) U.S. Cl. 370/328; 370/503; 370/469; 370/338

(57) ABSTRACT

A communications apparatus includes: a timer for updating time information at a cycle longer than a cycle of a clock signal by a factor of n1 (n1>1 is a constant natural number); a frame generation section for generating frames each of which includes the time information; a transmission section; and a control section for instructing the modulation section to transmit the frames to other communications apparatus. The frame generation section sequentially transmits the generated frames to the transmission section. The control section instructs the transmission section to transmit the frames when a time longer than the cycle of the signal by a factor of n2 (n2 is a constant natural number) passes after the time information is updated.

This Nonprovisional application claims priority under 35 U.S.C. § 119(a) on Patent Application No. 3222/2005 filed in Japan on Jan. 7, 2005 and Patent Application No. 371180/2005 filed in Japan on Dec. 23, 2005, the entire contents of which are hereby incorporated by reference.

### FIELD OF THE INVENTION

The present invention relates to (i) a communications apparatus for transmitting frames each of which requires synchronization, (ii) a communications method, (iii) a program, and (iv) a computer-readable storage medium storing the program.

### BACKGROUND OF THE INVENTION

Conventionally, a communications network having a plurality of terminal devices has been known. FIG. 13 schematically illustrates such a communications network. As illustrated in FIG. 13, a communications network 70 includes a terminal device 71, a terminal device 72, and a terminal device 73. Further, the terminal device 71 has a communications apparatus 81, the terminal device 72 has a communications apparatus 82, and the terminal device 73 has a communications apparatus 83. Note that, in the following description, the terminal device 71 functions as a transmitting end apparatus and each of the terminal devices (72 and 73) functions as a receiving end apparatus. Further, for convenience in explanation, the following description explains a case where the terminal device 71 functions as an AP (Access Point) and each of the terminal devices 72 and 73 functions as an STA (Station).

Here, in case where the data is stream data which requires real-time process (e.g., video data, sound data, and the like), timers of the communications apparatuses 81 to 83 have to be synchronized with each other (with high accuracy). Further, in case of transmitting data from the communications apparatus 81 to the communications apparatuses (82 and 83), it is necessary to carry out the synchronization in order to confirm whether or not the data has been transmitted without fail. Further, the communications apparatus 81 transmits the data in a frame format, so that there is a difficulty in sequential control of frames in terms of timings. Thus, the synchronization is required.

However, as illustrated in FIG. 14, it is general that a timer of a communication apparatus is likely to tick faster or more slowly than a timer always indicating a standard time (hereinafter, referred to as a standard timer). Thus, a time of the timer of the communications apparatus greatly deviates from a time of the standard timer. Generally, the timers of the communications apparatuses 81 to 83 are different from each other in terms of ticking speed. Therefore, as illustrated in FIG. 15, the communications apparatuses are different from each other in terms of time.

Therefore, in the communications network 70 arranged in the foregoing manner, it is necessary to regularly adjust the timers of the communications apparatuses 81 to 83 so as to keep pace with each other. Hereinafter, in case where a “timer of a terminal device” is recited, this means a timer of a communications apparatus in a terminal device.

An example of a method for adjusting the timers so as to keep pace with each other is a method in which a time of the timer of the communications apparatus is made to correspond to a time of a timer of another communications apparatus. For example, in case of wireless LAN (Local Area Network) which is in compliance with IEEE802.11, the foregoing method is adopted. Specifically, as illustrated in FIG. 16, a timer of each STA on the network is adjusted so as to keep pace with a timer of the AP (terminal device) in the wireless LAN.

Further, an example of other method for adjusting the time of the timer is as follows: As illustrated in FIG. 17, a time of a timer of a terminal device C which receives data (the terminal device C corresponds to each of the terminal devices 72 and 73 in FIG. 13) is adjusted so as to keep pace with a time of a timer of a terminal device B which transmits the data (the terminal device B corresponds to the terminal device 71 in FIG. 13).

Incidentally, in FIG. 17, taking into consideration a case where data which requires synchronization is transmitted from the terminal device A to the terminal device B, it is necessary to adjust the timer of the terminal device A so that the timer of the terminal device A keeps pace with the timer of the terminal device B. Here, when there is a single timer of the terminal device B, a time of the timer of the terminal device C is adjusted so as to indirectly keep pace with a time of the timer of the terminal device A. Therefore, it is difficult to realize highly accurate synchronization between the terminal devices C and B. Thus, it is preferable to provide the terminal device B with a timer for the terminal device A and a timer for the terminal device C.

In each of the foregoing methods, a timer of a terminal device is adjusted so as to keep pace with a timer of another terminal device. The following specifically explains the method for adjusting a timer of a terminal device so that the timer keeps pace with a timer of another terminal device.

FIG. 18 illustrates a case where data is transmitted from the communications apparatus 81 via a communications path r to the communications apparatus 82. Further, FIG. 18 illustrates an arrangement in which the timer of the communications apparatus 82 is adjusted so as to keep pace with the timer of the communications apparatus 81. Further, the communications apparatus 81 includes a timer 101, a frame generation section 102, and a modulation section 103. The communications apparatus 82 includes a demodulation section 111, a frame analysis section 112, and a synchronization section 113. Further, the synchronization section 113 includes a timer 114.

The timer 101 of the communication apparatus 81 updates time information stored in a register provided in the timer 101 at a certain cycle (Ts). Hereinafter, a time indicated by the time information is referred to as timestamp updated time. Further, Ts is referred to as a time information update cycle.

The frame generation section 102 samples a time of the timer 101 (specifically, the frame generation section 102 samples time information stored in the register). Hereinafter, the sampled time information is referred to as timestamp data. Further, the frame generation section 102 generates a frame f by combining the timestamp data, header, and data transmitted from an apparatus which is higher layer to the communications apparatus 81 (specifically, data transmitted from the terminal device 71 excluding the communications apparatus 81)(hereinafter, the data is referred to as higher layer data). The frame f is transmitted to the modulation section 103 so as to be modulated. Thereafter, the modulated frame f is transmitted to the demodulation section 111 of the communications apparatus 82 via the communications path r. Note that, for convenience in explanation, the frame transmitted to the communications apparatus 82 which functions as a receiving end is referred to as a frame f′.

The demodulation section 111 demodulates the modulated frame f′. Further, the frame f′ having been demodulated is transmitted to the frame analysis section 112. The frame analysis section 112 analyzes the frame f′ so as to extract the higher layer data and the timestamp data. Further, the frame analysis section 112 transmits the higher layer data to an apparatus higher layer to the communications apparatus 82 (specifically, to the terminal device 72 excluding the communications apparatus 82). Further, the frame analysis 112 transmits the timestamp data to the synchronization section 113. Further, the synchronization section 113 uses the timestamp data, having been transmitted from the frame analysis section 112, so as to update the time of the timer 114. An example of the method for updating the time is a method (first update method) in which the time is updated by directly using the timestamp data as illustrated in FIG. 19 based on IEEE802.11.

Note that, as an example, FIG. 18 illustrates an arrangement in which the timestamp data and the higher layer data are included in a single frame, but the arrangement is not limited to this. For example, as indicated by IEEE802.11TGe standard, a non-data frame including no higher layer data may be used.

Here, a specific example of a case where the first update method is adopted is described as follows with reference to FIG. 20. Each of three horizontal axes in FIG. 20 shows a time of the timer 101. That is, FIG. 20 is based on the time of the timer 101. Further, each of times t1 to t6 indicates a time in which the sampling is carried out by the frame generation section 102 (hereinafter, the time is referred to as a sampling time). The time tn is included in a frame fn as the time data where n is a natural number ranging from 1 to 6. Further, frames f1 to f6 are received by the communications apparatus 82. Note that, in FIG. 20, frames received by the communications apparatus 82 are respectively indicated as frames f1′ to f6′ so as to correspond to the frames f1 to f6.

Further, in a time tn′, the synchronization section 113 of the communications apparatus 82 uses the timestamp data included in the frame fn′ so as to update the timer 114. Thus, a time (tn) indicated by the timestamp data obtained by carrying out the sampling in the communications apparatus 81 at the time tn corresponds to a time of the timer 114 of the communications apparatus 82 at a time tn′. That is, at the time tn (the time of the timer 101 of the communications apparatus 81), the time of the timer 101 is tn and the time of the timer 114 is tn′. Hereinafter, the time tn′ is referred to as a timer update time.

Further, in FIG. 20, each of d1 to d6 indicates a difference (delay time) between each sampling time and each timer update time corresponding thereto. That is, dn indicates a value obtained by subtracting tn from tn′ where n is a natural number ranging from 1 to 6.

Incidentally, as illustrated in FIG. 20, unevenness occurs in the differences (d1 to d6). Reasons for this are:

(1) a difference in a communications time in the communications path r; (2) a difference in a time taken for the transmitting end communications apparatus 81 to carry out the frame generation; (3) a difference in a time taken for the modulation section 103 to carry out the modulation; (4) a difference in a time taken for the receiving end communications apparatus 82 to carry out the frame analysis; (5) a difference in a time taken for the demodulation section 111 to carry out the demodulation; and the like.

Further, a broken line in FIG. 20 shows a case where it is assumed that the timer 101 of the communications apparatus 81 keeps pace with the timer 114 of the communications apparatus 82. In this case, a difference between a time of the timer 101 and a time of the timer 114 is dn which is a constant value between the time tn′ and tn+1′. Thus, a jitter (i.e., a fluctuation band of a difference between the timer 101 and the timer 114) is |d2−d4| (jitter 1 in FIG. 20). Hereinafter, the “jitter” recited without any modification is the fluctuation band of the difference between the timer 101 and the timer 114.

While, a continuous line corresponding to each broken line indicates a case where the timer 114 ticks more slowly than the timer 101. In this case, when a time difference between both the timers just before the time t5′ is d4′, the jitter is |d2−d4′| (jitter 2 in FIG. 20). That is, in this case, a value of the jitter is longer than the case where both the timers keep pace with each other. Further, also in a case where the timer 114 ticks faster than the timer 101, a value of the jitter is larger than the case where both the timers keep pace with each other.

In this way, when a pace at which the receiving end timer 114 ticks is different from a pace at which the transmitting end timer 101 ticks, the value of the jitter is larger.

Note that, each of the time differences explained in the reasons (2) and (3) can be vanished by incorporating the timestamp data into the frame at the time of input of the frame f into the modulation section 103 so that a time taken to transmit the frame to the communications path r after entering the frame to the modulation section 103 is constant. Further, each of the time differences explained in the reasons (4) and (5) can be vanished by considering a time taken to carry out the demodulation and a time taken to analyze the frame at the time of update of the timer.

Incidentally, in case where the method based on the arrangement illustrated in FIG. 19 (the first update method) is adopted in the wireless LAN based on IEEE802.11 standard, the jitter ranges from 4 μs to 10 μs. However, the value of the jitter may be excessively large depending on a kind of the data transmitted between the communications apparatuses 81 and 82. In case of transmitting stream data of MPEG2 (Motion Picture Expert Group 2) for example, when the jitter exceeds 500 ns, qualities of video and sound that are reproduced in the receiving end terminal device 71 deteriorate. Further, in case of transmitting isochronous data defined in IEEE1394 standard, it is required that the jitter is 100 ns.

In order to reduce the jitter, it is necessary to adopt a method different from the first update method. An example of the method is a method in which a PLL (Phase Locked Loop) circuit is used to update a time (second update method). FIG. 21 illustrates an arrangement in which the synchronization section 113 includes the PLL circuit.

According to the arrangement in which the synchronization section 113 includes the PLL circuit, as illustrated by a continuous line in FIG. 22, when a certain time passes after starting the control, the time difference between the timer 101 and the timer 114 is stabilized within a range of relatively small values. In FIG. 22, a broken line indicates the time difference between the timer 101 and the timer 114 in case where the PLL circuit is not provided. In case where the PLL circuit is provided, a jitter after the certain time passes is smaller than that in case where the PLL circuit is not provided.

Incidentally, values of Kₚ (proportional element) and K_{I} (integral element) that are shown in FIG. 21 are influenced by jitter accuracy (i.e., smallness in the fluctuation band of the difference between the timer 104 and the timer 114) and a time taken to stabilize the difference. For example, in case where the values of Kₚ and K_{I} are made larger as illustrated by a thin line (thinner continuous line) in FIG. 23, a time taken to stabilize the difference (from 0 to TF in FIG. 23) is short, but the jitter accuracy after TF time passes is low. That is, the jitter becomes larger to some extent. While, in case where the values of Kₚ and K_{I} are made smaller, as illustrated by a broken line in FIG. 23, the jitter accuracy is high, but a time taken to stabilize the difference (from 0 to TL in FIG. 23) is long.

In case of using the PLL circuit, a method in which Kₚ and K₁ are controlled as time parameters is adopted. Specifically, the values of Kₚ and K_{I} are made larger in starting the control, and the values of Kₚ and K_{I} are made gradually smaller. In FIG. 23, Kₚ and K_{I} are made smaller in a time TG1 and a time TG2. On this account, as illustrated by a bold line in FIG. 23, it is possible to stabilize the difference between the timer 101 and the timer 114 in a time TM earlier than a time TL. In other words, it is possible to achieve a highly accurate jitter in the time TM earlier than the time TL.

However, even when Kₚ and K_{I} are controlled, it is impossible to reduce the jitter to a predetermined value in a short time. For example, in case of complying with the IEEE802.11 standard, it take several dozen minutes to achieve a jitter of several hundreds ns.

A state in which it is impossible to reduce the jitter to a predetermined value in a short time even by using the PLL circuit is caused by timestamp repetition and timestamp transmission jitter. First, the timestamp repetition is explained as follows.

In case where the PLL circuit is provided on the synchronization section 114 of the receiving end communications apparatus 82, when the timestamp repetition is raised (that is, repetition of a frame including the timestamp data is raised), it is possible to frequently switch between Kₚ and K_{I}. Thus, it is possible to reduce a time taken to stabilize the difference. Therefore, it is preferable to raise the timestamp repetition. However, when the repetition of the frame including the timestamp data is raised, an overhead in a radio band become larger accordingly, so that such a high repetition of the frame may be unfavorable.

Next, the timestamp transmission jitter is explained as follows.

The timestamp transmission jitter is represented by a fluctuation band of a difference between (i) a time at which the frame including the timestamp data comes to be outputted from the modulation section 103 to the communications path r and (ii) a time at which the timestamp data included in the frame is updated. That is, an absolute value of a difference between (a) a maximum value of the difference between both the times and (b) a minimum value of the difference between both the times.

Further, the time information is updated at a certain cycle (Ts), so that the timestamp transmission jitter can be regarded also as a fluctuation band in the difference between the time at which the frame including the timestamp data comes to be outputted from the modulation section 103 to the communications path r and the timestamp update time just before the time at which the frame comes to be inputted to the modulation section 103.

Here, the following explains the timestamp transmission jitter on the assumption that an error in a time taken to carry out the modulation in the modulation section 103 after starting to input the frame into the modulation section 103 is 0 (on the assumption that an error in the processing time required in the modulation section 103 is 0).

Generally, a difference between the time at which the frame including the timestamp data comes to be inputted to the modulation section 103 and the timestamp update time just before the foregoing time (hereinafter, this timestamp update time is referred to as a just-before timestamp update time) (the difference is a delay time in short) is not constant. That is, as illustrated in FIG. 24, a delay time Td1 concerning a frame 1, a delay time Td2 concerning a frame 2, and a delay time Td3 concerning a frame 3 are not necessarily identical with each other. Thus, when a maximum delay time is Tdmax and a minimum delay time is Tdmin, a fluctuation band represented by Tdmax−Tdmin occurs in connection with transmission of the frame including the timestamp data from the frame generation section 102 to the modulation section 103. Thus, in this case, the fluctuation band represented by Tdmax−Tdmin is the timestamp transmission jitter.

Note that, an interface (not shown) exists between the frame generation section 102 and the modulation section 103, so that the frame outputted from the frame generation section 102 comes to be inputted to the modulation section 103 after a predetermined time passes. Note that, the predetermined time is constant, so that this has no influence on the timestamp transmission jitter. Thus, explanation will be given without considering the foregoing time hereinafter. Further, for convenience in description, the following gives explanation on the assumption that an error in a time taken to carry out the modulation in the modulation section 103 after starting to input the frame into the modulation section 103 is 0.

Here, when the timestamp transmission jitter is larger, the foregoing jitter (the fluctuation band in the difference between the timer 101 and the timer 114) is larger and a time taken to stabilize the difference is longer. Thus, it is preferable to reduce the timestamp transmission jitter.

In IEEE802.11, the timestamp transmission jitter represented by Tdmax−Tdmin corresponds to the time information update cycle (Ts), and the only way to reduce the timestamp transmission jitter is to reduce Ts (for example, 10 ns). However, in this case, it is impossible to keep compatibility with respect to a conventional apparatus which is in compliance with the foregoing standard. Thus, it is practically impossible to reduce Ts in IEEE802.11.

Thus, in order to reduce the jitter to a predetermined value in a short time while keeping the compatibility with respect to the conventional apparatus, it is necessary to reduce the timestamp transmission jitter in another manner.

Incidentally, in the IEEE802.11 standard, the timestamp data is included in a beacon frame. Note that, the beacon frame is a frame which does not include the aforementioned higher layer data. Hereinafter, the beacon frame is referred to as a beacon.

The AP (the terminal device 71 including the communications apparatus 81) broadcasts the beacon to all the STAs. Further, each of all the STAs having received the beacon adjusts its timer by using the timestamp data included in the beacon. Further, in the foregoing standard, the beacon is transmitted from the frame generation section 102 via the modulation section 103 to the communications path r generally at a cycle of about 100 ms. Further, a timer (timer 101) of the AP updates the time information with respect to a register provided in the timer 101 at each μs. That is, Ts=1 μs. FIG. 25 corresponds to FIG. 24 in case of the IEEE802.11 standard. FIG. 25 illustrates the beacon instead of the frame. As described above, Ts is 1 μs in FIG. 25.

Further, it is general that a cycle of a clock signal used in the frame generation section 102 (hereinafter, the cycle is referred to as a clock cycle) is 1 μs/N (N is an integer not less than 2). Further, also in the timer 101, the time information is updated at each μs in synchronization with the clock signal. Thus, the time information of the register is updated for every N number of timers.

Incidentally, as illustrated in FIG. 26(a), if a time difference inputted to the modulation section 103 can be always set to be 1 μs×K (K is a positive integer) concerning beacons sequentially transmitted, the timestamp transmission jitter can be made 0. However, the time difference cannot be kept as 1 μs×K in practice. A reason for this is explained as follows.

In case where a plurality of terminal devices transmit frames to the communications path and the frames exist in the communications path, none of the frames are exactly transmitted. Thus, in IEEE802.11, when a terminal device is transmitting a frame (including a beacon), another terminal device is not allowed to transmit a frame until the foregoing transmission of the frame is completed.

Thus, as illustrated in FIG. 26(b), the frame transmitted by the STA (a terminal device other than the terminal device 71) prevents the AP (i.e., the terminal device 71) from transmitting the beacon 2 at a predetermined interval (1 μs×K) from the beacon 1. As a result, the communications apparatus 81 cannot always keep the time difference at 1 μs×K as described above.

Incidentally, in the foregoing case, the AP does not transmit the beacon 2 until the time (TE in FIG. 26(b)) at which the STA finishes transmission of the frame. Further, a predetermined time is required as an interval between a frame and another frame (including the beacon). In case of carrying out communications by using a physical layer (here, the modulation section 103 and the demodulation section 111) which is in compliance with the IEEE802.11 standard, a time within a range of 25±0.9 μs is defined as the predetermined time. Further, the predetermined time is referred to as PIFS (Point Coordination Function Interframe Space).

Next, the timestamp transmission jitter which can occur in the IEEE802.11 standard is described as follows.

FIG. 27 illustrates an arrangement of a general AP communications apparatus which is in compliance with the IEEE802.11 standard. Hereinafter, explanation is given on the assumption that the communications apparatus 81 has this arrangement. That is, the communications apparatus 81 includes not only the timer 101, the frame generation section 102, and the modulation section 103, all of which are illustrated in FIG. 18, but also at least a control section 104 and a demodulation section 105. Further, explanation is given on the assumption that the predetermined time is 25 μs. Further, explanation is given on the assumption that a clock signal used in the frame generation section 102 is used also in the control section 104.

The control section 104 generates a TX_BEACON signal therein. Further, as illustrated in FIG. 28, the TX_BEACON signal is a pulse wave which is ordinarily in an OFF level state and becomes in an ON level state at a predetermined timing.

Further, the control section 104 generates a WAIT signal and a TX_START signal therein. Further, the control section 104 transmits the TX_START signal to the modulation section 103. Note that, the WAIT signal is a level signal and the TX_START signal is a pulse wave. Both a case where the WAIT signal is in an ON level state and a case where the TX_START signal is in an ON level state will be described later.

The demodulation section 105 generates a CCA (Clear Channel Assessment) signal therein and transmits the CCA signal to the control section 104. Further, the demodulation section 105 makes the CCA signal into an ON level state while a frame exists in the communications path r (that is, while the demodulation section 105 is receiving the frame). Further, while the control section 104 is receiving the CCA signal in the ON level state, the control section 104 cannot instruct the modulation section 103 to start modulation of the beacon.

Further, when the demodulation section 105 does not receive the frame, the CCA signal becomes into OFF, and the control section 104 having recognized this condition keeps the WAIT signal in the ON level state therein for a predetermined time (25 μs−TP). Note that, the TP is a time taken for the modulation section 103 to begin outputting the modulated beacon to the communications path r after beginning the modulation.

The control section 104 makes the TX_START signal into the ON level state at the time when the WAIT signal changes into the OFF level state from the ON level state. Further, in case where the modulation section 103 receives the TX_START signal in the ON level state from the control section 104, the modulation section 103 starts the modulation. Further, when the TP time passes after the TX_START signal become in the ON level state, the modulated beacon is transmitted to the communications path r. On this account, when 25 μs passes after the demodulation section 105 finishes receiving the frame, the beacon is outputted to the communications path.

Note that, the TX_START signal causes the modulation section 103 to start the modulation. Actually, the frame data is given to the modulation section 103 when the TX_START signal becomes into the OFF state again and a certain time passes, and the time varies depending how the modulation is set up in the modulation section 103. Thus, the control section 104 has to transmit to the modulation section 103 an instruction to generate the beacon by the time at which the control section 104 begins to give the data to the modulation section 103. However, the timing at which it is possible to give the instruction to generate the beacon is relatively long, so that various implementation methods can be adopted and the timing at which the instruction to generate the beacon is given does not influence the timestamp transmission jitter. Thus, explanation of the timing at which the instruction to generate the beacon is omitted.

Note that, a reason for which the modulated beacon is transmitted when the TP time passes after the TX_START signal becomes in the ON level state is as follows: it takes some time to carry out the modulation including preamble generation.

With reference to FIG. 29, the following explains how the control section 104 carries out processes until the TX_START signal becomes into the ON level state as illustrated in FIG. 28. Note that, in FIG. 29, an ON level state of each signal is 1 and an OFF level state of each signal is 0.

First, the control section 104 makes the TX_START signal into the OFF level state (S91). After carrying out the step S91, the control section 104 determines whether the TX_BEACON signal is in the ON level state or not (S92). When the TX_BEACON signal is not in the ON level state in S92, the process returns to the step S92. While, when the TX_BEACON signal is in the ON level state in S92, the control section 104 determines whether or not the CCA signal is in the OFF level state and the WAIT signal is in the OFF level state (S93).

When at least one of both the signals is determined to be in the ON level state in S93, the process returns to the step S93. While, when both the signals are determined to be in the OFF level state in S93, the TX_START signal is kept in the ON level state for a certain time and then the TX_START signal is made into the OFF level state (S94). Further, after carrying out the step S94, the process returns to S92 again. In this manner, a series of processes is finished.

Incidentally, the TP is a certain time in the IEEE802.11 standard. Further, a fixed value within the range of 25±0.9 μs as the aforementioned PIFS (in this example, the fixed value is 25 μs). Further, the timing at which the CCA signal becomes in the OFF level state varies depending on a condition under which the frame (including the beacon) is transmitted and a similar condition. Therefore, a difference between the time at which the CCA signal becomes in the OFF level state and the timestamp update time just before becoming into the OFF level state is not constant.

Therefore, a difference between a time at which the beacon is outputted from the modulation section 103 to the communications path r and the aforementioned timestamp update time just before becoming into the OFF level state is not always constant.

Further, as illustrated also in FIG. 25, a difference (delay time) between the time at which the beacon is inputted to the modulation section 103 and the timestamp update timer just before becoming into the OFF level state is not constant.

Further, a minimum value of the delay time is 0. While, a clock cycle in each of the control section 104 and the frame generation section 102 is 1 μs/N, so that a maximum value of the delay time is (1 μs/N)×(N−1). That is, the value is longer than the clock cycle by a factor of (N−1). Thus, this results in occurrence of the timestamp transmission jitter whose value reaches up to the clock cycle×(N−1).

As described above, even in the case where the timestamp data is transmitted as the frame including the higher layer data or even in the case where the timestamp data is included in the beacon so as to be transmitted, the timestamp transmission jitter never fails to occur. If a communications apparatus transmitting the timestamp data is operated for a long time, the timestamp transmission jitter never fails to have a value of the clock cycle×(N−1).

Further, as described above, in case where a value of the timestamp transmission jitter is large as in the conventional arrangement, it is impossible to reduce the jitter in a short time. Thus, in case of treating stream data such as MPEG2 and the like, it is necessary to reduce the timestamp transmission jitter in order to reproduce high-quality video and sound in the receiving end terminal device 72.

However, currently, the reduction of the timestamp transmission jitter has not been tried not only in the IEEE802.11 standard but also in other standards.

### SUMMARY OF THE INVENTION

An object of the present invention is to provide (i) a communications apparatus which can reduce the timestamp transmission jitter, (ii) a communications method, (iii) a program, and (iv) a computer-readable storage medium storing the program.

In order to solve the problems, a communications apparatus according to the present invention includes: signal generation means for generating a signal having a certain cycle; time update means for updating time information at a predetermined cycle longer than the certain cycle by a factor of n1 (n1>1 is a constant natural number); frame generation means for obtaining the time information so as to generate frames each of which includes the time information; transmission means for sequentially transmitting the frames, generated by the frame generation means, to other communications apparatus; and control means for instructing the transmission means to transmit the frames to said other communications apparatus, wherein: the frame generation means sequentially transmits to the transmission means the frames that have been generated, and the control means instructs the transmission means to transmit the frames when a time longer than the cycle of the signal by a factor of n2 (n2 is a constant natural number) passes after the time information is updated.

According to the foregoing arrangement, the signal generation means generates the signal having a certain cycle. Further, the time update means updates the time information at a predetermined cycle longer than the certain cycle by a factor of n1 (n1>1 is a constant natural number). Moreover, the frame generation means generates frames each of which includes the time information, and the transmission means sequentially transmits the frames to other communications apparatus.

Further, according to the foregoing arrangement, in synchronization with the signal generated by the signal generation means, the time update means and the control means give an instruction to transmit the frames when a time longer than the cycle of the signal by a factor of n2 (n2 is a constant natural number) passes after the time information is updated. Thus, a timestamp transmission jitter generated in a MAC layer which is in compliance with IEEE802.11 standard can be made 0 for example.

As a result, it is possible to provide a communications apparatus which can make the timestamp transmission jitter smaller than the conventionally occurring timestamp transmission jitter.

In order to solve the problems, a communications apparatus according to the present invention includes: a signal generation section for generating a signal having a certain cycle; a time update section for updating time information at a predetermined cycle longer than the certain cycle; a frame generation section for obtaining the time information so as to generate frames each of which includes the time information; a transmission section for sequentially transmitting the frames, generated by the frame generation section, to other communications apparatus; and a control section for instructing the transmission section to transmit the frames to said other communications apparatus, wherein: the frame generation section sequentially transmits to the transmission section the frames that have been generated, and in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time.

According to the foregoing arrangement, the time update means and the control means generate a signal having a certain cycle which can cover a case where there is no synchronization with the signal generated by the signal generation means. In this case, the time update means updates the time information at a predetermined cycle longer than the certain cycle. Moreover, the frame generation means generates frames each of which includes the time information, and the transmission means sequentially transmits the frames to other communications apparatus.

Further, in case where a time at which the time information is updated just before instructing the transmission means to transmit the frames is a just-before-transmission-instruction time, the control means instructs the transmission means to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time.

Therefore, a fluctuation band of a difference (time) between the time at which the transmission section is instructed to transmit the frames and the time at which the time information is updated just before instructing the transmission section to transmit the frames can be always kept within a single cycle of the signal. Further, the time information is updated at a predetermined cycle.

Thus, a fluctuation band of a difference between the time at which the transmission section is instructed to transmit the frames and the time at which the timestamp data included in each frame is updated can be always kept within a single cycle of the signal.

Further, the frame generation section sequentially transmits the generated frames to the transmission section. Further, the frames outputted from the frame generation section are identical with each other in terms of a time at which each frame comes to be inputted to the transmission section.

Therefore, also a fluctuation band of a difference between the time at which the frame including the time information comes to be outputted from the transmission section to other apparatus and the time at which the timestamp data included in the frame is updated (that is, a timestamp transmission jitter) can be always kept within a single cycle of the signal. Further, a single cycle of the signal is shorter than an upper limit of the conventionally occurring timestamp transmission jitter, i.e., a cycle at which the time information is updated (that is, the predetermined cycle).

Thus, it is possible to provide a communications apparatus which can make the timestamp transmission jitter smaller than the conventionally occurring timestamp transmission jitter.

In order to solve the foregoing problems, a communications apparatus according to the present invention transmits frames each of which includes timestamp information to other communications apparatus, said timestamp information being obtained by sampling time information updated at a predetermined cycle, wherein in case where two arbitrary frames out of the frames are first and second frames, and a difference between a time indicated by timestamp information included in the first frame and a time indicated by timestamp information included in the second frame is a first difference, and a difference between a time at which the first frame comes to be transmitted to said other communications apparatus and a time at which the second frame comes to be transmitted to said other communications apparatus is a second difference, and a difference between the first difference and the second difference is regarded as a sample, a value obtained by dividing a standard deviation of the sample by the predetermined cycle is less than 0.1443376.

According to the foregoing arrangement, a difference between the maximum value an the minimum value of the sample corresponds to the timestamp transmission jitter.

Further, in case where the timestamp transmission jitter which occurs between the communications apparatus and other communications apparatus is half of the determined cycle and distribution of the timestamp transmission jitter is uniform, a standard deviation of the difference is 0.1443376 of the predetermined cycle.

Thus, in case where it is necessary that the timestamp transmission jitter is less than half of the predetermined cycle, it is possible to reduce the timestamp transmission jitter to a value which substantially realizes the foregoing condition.

In order to solve the foregoing problems, a communications apparatus according to the present invention transmits frames each of which includes timestamp information to other communications apparatus, said timestamp information being obtained by sampling time information updated at a predetermined cycle, wherein in case where a difference between a time at which the frames come to be transmitted to said other communications apparatus and a time at which the timestamp information included in each of the frames is regarded as a sample, a value obtained by dividing a standard deviation of the sample by the predetermined cycle is less than 0.1443376.

According to the foregoing arrangement, a difference between the maximum value an the minimum value of the sample corresponds to the timestamp transmission jitter.

Further, in case where the timestamp transmission jitter which occurs between the communications apparatus and other communications apparatus is half of the determined cycle and distribution of the timestamp transmission jitter is uniform, a standard deviation of the difference is 0.1443376 of the predetermined cycle.

Thus, in case where it is necessary that the timestamp transmission jitter is less than half of the predetermined cycle, it is possible to reduce the timestamp transmission jitter to a value which substantially realizes the foregoing condition.

In order to solve the foregoing problems, a communications method according to the present invention is a communications method in which transmission means instructed to transmit frames transmits frames generated by frame generation means to other communications apparatus, and the communications method includes: a signal generation step in which a signal having a certain cycle is generated; a time update step in which time information is updated at a cycle longer than the certain cycle by a factor of n1 (n1>1 is a constant natural number); an instruction step in which the transmission means is instructed to transmit the frames when a time longer than the cycle of the signal by a factor of n2 (n2 is a constant natural number) passes after the time information is updated; a frame generation step in which the time information is obtained so that each frame including the time information is generated; and a transmission step in which the frames generated by the frame generation means are sequentially received and the frames are sequentially transmitted to said other communications apparatus.

According to the foregoing arrangement, as in the foregoing communications apparatus, the transmission means is instructed to transmit the frames when a time longer than the cycle of the signal by a factor of n2 (n2 is a constant natural number) passes after the time information is updated. Thus, a timestamp transmission jitter generated in a MAC layer which is in compliance with IEEE802.11 standard can be made 0 for example.

Thus, it is possible to provide a communications method by which the timestamp transmission jitter can be made smaller than the conventionally occurring timestamp transmission jitter.

In order to solve the foregoing problems, a communications method according to the present invention is a communications method in which a transmission section instructed to transmit frames transmits frames generated by a frame generation section to other communications apparatus, and the communications method includes: a signal generation step in which a signal having a certain cycle is generated; a time update step in which time information is updated at a cycle longer than the certain cycle; an instruction step in which, in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time; a frame generation step in which the time information is obtained so that each frame including the time information is generated; and a transmission step in which the frames generated by the frame generation section are sequentially received and the frames are sequentially transmitted to said other communications apparatus.

According to the foregoing method, as in the aforementioned communications apparatus, a fluctuation band of a difference (time) between the time at which the transmission section is instructed to transmit the frames and the time at which the time information is updated just before instructing the transmission section to transmit the frames can be always kept within a single cycle of the signal.

Thus, it is possible to provide a communications method by which the timestamp transmission jitter can be made smaller than the conventionally occurring timestamp transmission jitter.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 illustrates a relationship between (i) a timestamp update time and (ii) a modulation instruction time and a frame transmission instruction time.

FIG. 2 illustrates a relationship between (i) a timestamp update time and (ii) a modulation instruction time and a frame generation instruction time in case where there is a timing difference between a clock signal for a timer and a clock signal for a control section.

FIG. 3 schematically illustrates a communications apparatus according to the present embodiment.

FIG. 4 illustrates an arrangement of the control section of the communications apparatus.

FIG. 5 illustrates a difference between a time at which a frame is inputted from a frame generation section to a modulation section and a time at which the frame is outputted from the modulation section to a communications path.

FIG. 6 illustrates a difference between a time at which generation of the frame is started and a timestamp update time just before the time for starting the generation of the frame.

FIG. 7 illustrates, concerning two arbitrary frames, that a difference between a time at which the one frame is outputted from the modulation section to the communications path and a time at which the other frame is outputted from the modulation section to the communications path is a multiple number of a cycle at which time information is updated.

FIG. 8 illustrates, concerning two arbitrary beacons, that a difference between a time at which the one beacon is outputted from the modulation section to the communications path and a time at which the other beacon is outputted from the modulation section to the communications path is a multiple number of a cycle at which time information is updated.

FIG. 9 is a timing chart illustrating timings for switching among a signal received by the control section, a signal generated in the control section, and a signal outputted from the modulation section.

FIG. 10 illustrates that a time difference between a time at which input of the beacon into the modulation section is started and a timestamp update time just before starting the input of the beacon is constant.

FIG. 11 is a flowchart illustrating how a signal is processed by the control section.

FIG. 12 illustrates a case where each timestamp transmission jitter is half of a predetermined cycle and distribution of timestamp transmission jitters is uniform.

FIG. 13 illustrates, concerning a conventional technique, a communications network constituted of terminal devices each of which is provided with a communications apparatus.

FIG. 14 illustrates a relationship between a pace at which a timer of the communications apparatus ticks and a pace of a standard time.

FIG. 15 illustrates how time information is exchanged between the communications apparatuses.

FIG. 16 illustrates how to adjust a time of each timer in each station (STA) to a time of a timer provided in an access point (AP).

FIG. 17 illustrates how to adjust a time of a timer provided in a terminal device to a time of a timer in another terminal device.

FIG. 18 schematically illustrates arrangements of a transmitting end communications apparatus and a receiving end communications apparatus, and illustrates formats of transmitted/received frames.

FIG. 19 illustrates how to update a timer of a receiving end timer by directly using timestamp data.

FIG. 20 illustrates a jitter which occurs between the transmitting end communications apparatus and the receiving end communications apparatus.

FIG. 21 illustrates an arrangement of a PLL circuit provided on a synchronization section of the communications apparatus.

FIG. 22 illustrates a jitter in case where the synchronization section is provided with the PLL circuit and a jitter in case where the synchronization section is provided with no PLL circuit.

FIG. 23 is a graph illustrating a relationship between a jitter and a time required in stabilization in case where a proportional element and an integral element of the PLL are changed.

FIG. 24 illustrates that a difference between the time at which input of the frame into the modulation section is started and the timestamp update time just before starting the input of the frame is not constant.

FIG. 25 illustrates that a difference between the time at which input of the beacon into the modulation section is started and the timestamp update time just before starting the input of the beacon is not constant.

FIG. 26(a) illustrates a case where a difference between sequentially transmitted beacons in terms of a time for inputting each beacon to the modulation section is larger by a factor of a natural number than an interval at which timestamp update is carried out. FIG. 26(b) illustrates a case where: since the communications apparatus is receiving the frame, it is impossible to transmit a subsequent beacon when a time longer than the interval by a factor of a natural number passes after a transmission time of a previous beacon.

FIG. 27 schematically illustrates other communications apparatus.

FIG. 28 is a timing chart illustrating timings for switching among a signal received by a control section of the aforementioned other communications apparatus, a signal generated in the control section, and a signal outputted from a modulation section.

FIG. 29 is a flowchart illustrating how a signal is processed in the control section of the aforementioned other communications apparatus.

### DESCRIPTION OF THE EMBODIMENTS

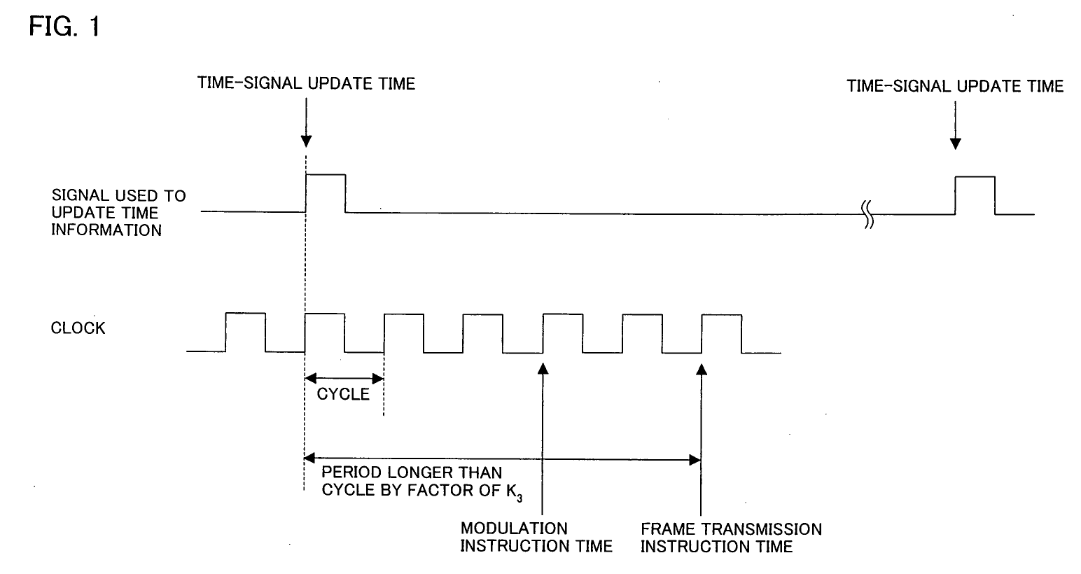

One embodiment of the present invention is described as follows with reference to FIG. 1 to FIG. 12.

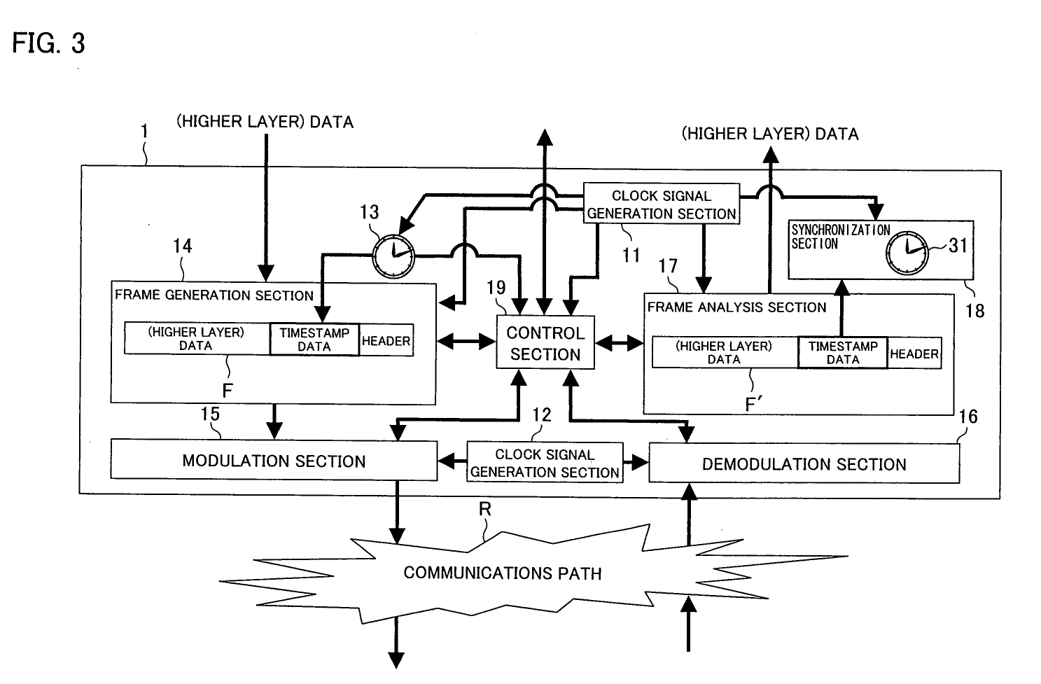

FIG. 3 schematically illustrates an arrangement of a communications apparatus 1 according to an embodiment of the present invention.

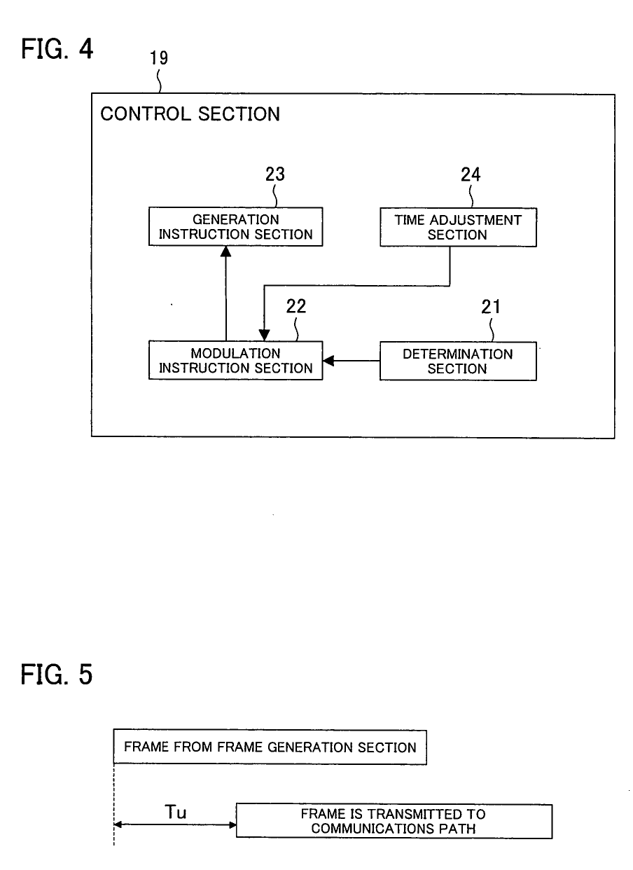

The communications apparatus 1 functions as both a transmitting end communications apparatus and a receiving end communications apparatus. Further, as illustrated in FIG. 3, the communications apparatus 1 includes a clock signal generation section (signal generation section) 11, a clock signal generation section 12, a timer (time update section) 13, a frame generation section (frame generation section) 14, a modulation section (transmission section) 15, a demodulation section 16, a frame analysis section 17, a synchronization section 18, and a control section 19. Further, as illustrated in FIG. 4, the control section includes a determination section 21, a modulation instruction section (instruction signal generation means) 22, a generation instruction section 23, and a time adjustment section (adjustment section) 24. Further, the synchronization section includes a timer 31.

The clock signal generation section 11 generates a signal (clock signal), having a certain cycle, which is used so that at least the respective sections (13, 14, 17 to 19) keep pace with each other. Further, the clock signal generation section 11 transmits the thus generated clock signal to the timer 13, the frame generation section 14, the frame analysis section 17, the synchronization section 18, and the control section 19. On this account, each process is carried out at a timing based on a cycle of a single clock signal in each section. Hereinafter, the cycle of the clock signal is T1.

The clock signal generation section 12 generates a signal, having a certain cycle, (clock signal) which is used to make the modulation section 15 and the demodulation section 16 keep pace with each other. Further, the clock signal generation section 12 transmits the thus generated clock signal to the modulation section 15 and the demodulation section 16. On this account, each process is carried out at a timing based on a cycle of a single clock signal in the modulation section 15. Hereinafter, for convenience in description, a cycle of the clock signal generated in the clock signal generation section 12 is T1 as in the cycle of the clock signal generated in the clock signal generation section 12.

Further, for convenience in description, the following explanation is given on the assumption that the clock signals generated in both the clock signal generation sections (11 and 12) are completely synchronized with each other. That is, the explanation is given on the assumption that processes are carried out in the respective sections (13 to 19) at a timing based on the cycle of the single clock signal.

The timer 13 updates time information, stored in a register provided in the timer 13, in accordance with the clock signal, at a certain cycle (T2). Further, the timer 13 transmits a signal, which indicates as a pulse wave that the time information has been updated, to the control section 19. Hereinafter, a time indicated by the time information is referred to as a timestamp update time. Further, T2 is referred to as a time information update cycle. Further, T2=N×T1 (N: constant natural number). That is, as in the conventional arrangement, when N-number of clock cycles pass, the time information is updated. Note that, the certain cycle (T2) corresponds to a “predetermined cycle” recited in claims.

The frame generation section 14 samples a time (in more detail, time information stored in the register) of the timer 13. Hereinafter, the thus sampled time information is referred to as timestamp data. Further, the frame generation section 14 generates a frame F, serving as a data frame, by combining header, the timestamp data, and data transmitted from an apparatus which is higher layer to the communications apparatus 1 (specifically, a terminal device connected to the communications apparatus 1) (hereinafter, the thus transmitted data is referred to as higher layer data).

The thus generated frame F is transmitted to the modulation section 15 so as to be modulated. Thereafter, the modulated frame F is transmitted via the communications path R to a demodulation section of another communications apparatus (not shown). However, in case where the frame generation section generates a frame which requires no timestamp data, the frame generation section 14 generates a frame including header and the aforementioned data without sampling the time of the timer 13. Hereinafter, the “frame” means a frame including the timestamp data.

Here, a timing at which the frame generation section 14 generates the frame is controlled by the control section 19. Further, in giving the frame to the modulation section 15, the control section 19 first transmits a modulation instruction to the modulation section 15 so as to start the modulation. How the control section 19 instructs the modulation section 15 to carry out the modulation will be detailed later. Then, the data is actually given from the frame generation section 14 to the modulation section 15. At this time, the frame generation section 14 has to start generation of the frame by the time when the data is given to the modulation section 15. Thus, the control section 19 has to instruct the frame generation section 14 to generate the frame in time for giving the data to the modulation section 15.

Note that, a timing for instructing the frame generation section 14 to generate the frame does not influence the timestamp transmission jitter. Further, a period of a timing at which it is possible to instruct the frame generation section 14 to generate the frame is relatively long, so that an implementation method widely varies. Thus, the timing for instructing the frame generation section 14 to generate the frame is out of the scope of the present invention, but the present embodiment will be explained on the assumption that the control section 19 instructs the frame generation section 14 to generate the frame after giving a modulation instruction to start the modulation. The detail description thereof will be given later.

Further, an interface (not shown) exists between the frame generation section 14 and the modulation section 15, so that the frame outputted from the frame generation section 14 comes to be inputted to the modulation section 15 when a predetermined time passes. However, the predetermined time is a certain time, so that this time does not influence the timestamp transmission jitter. Hereinafter, the following explanation is given without taking the predetermined time into consideration (that is, with the predetermined time regarded as 0).

The modulation section 15 receives the frame generated by the frame generation section 14 and modulates the frame. Further, the modulation section 15 generates also a preamble at the time of the foregoing modulation. Further, the modulation section 15 outputs the modulated frame to the communications path R. Here, a timing at which the modulation is started is controlled by the control section 19. How the control section 19 controls the timing at which the modulation is started will be described later. Further, other processes carried out in the modulation section 15 will be sequentially described later.

The demodulation section 16 receives a modulated frame transmitted from other communications apparatus. Further, the demodulation section 16 demodulates the received frame and transmits the demodulated frame (that is, a frame F′) to the frame analysis section 17.

Further, the demodulation section 16 generates a CCA (Clear Channel Assessment) signal therein and transmits the thus generated CCA signal to the control section 19. Further, the demodulation section 16 keeps the CCA signal in an ON level state during a period in which the frame exists in the communications path R (that is, during a period in which the frame is being received by the demodulation section 16).

The frame analysis section 17 analyses the frame F′ and extracts the higher layer data and the timestamp data. Further, the frame analysis section 17 transmits the higher layer data to an apparatus which is higher layer to the communications apparatus 1. Further, the frame analysis section 17 transmits the timestamp data to the synchronization section 18. Note that, in case where the timestamp data is not included in the frame F′, transmission of the timestamp data is not carried out.

The synchronization section 18 receives the timestamp data transmitted from the frame analysis section 17. Further, the synchronization section 18 updates the time of the timer 31 by using the timestamp data.

The control section 19 controls whole the communications apparatus 1.

The control section 19 receives the clock signal from the clock signal generation section 11 and acquires a signal, which indicates as a pulse wave that the time information has been updated, from the timer 13. Further, the control section 19 receives the CCA signal from the demodulation section 16. Further, the determination section 21 of the control section 19 determines a level state of the CCA signal. Further, in case where the determination section 21 determines that the CCA signal is in an OFF level state, the determination section 21 transmits a signal, which indicates that the modulation is allowed, to the modulation instruction section 22.

In case where the modulation instruction section 22 receives from the determination section 21 the signal which indicates that the modulation is allowed, the modulation instruction section 21 instructs the modulation section 15 to modulate the frame at a predetermined timing. Here, in case where the modulation section 15 is instructed to modulate the frame, as illustrated in FIG. 5, the modulation section 15 starts the modulation and begins to output the modulated frame to the communications path R when a predetermined time (Tu) passes. Note that, the modulation instruction corresponds to “instructs the transmission section to transmit the frames” recited in claims. Note that, the Tu corresponds to a certain time recited in claims.

Further, in case where the modulation instruction section 22 receives from the demodulation section 16 the CCA signal in the OFF level state when the aforementioned period passes, the modulation instruction section 22 instructs the modulation section 15 to carry out the modulation when a time (variable time) determined for each frame (hereinafter, referred to as a TA time) passes. The time adjustment section 24 adjusts the time (TA) determined for each frame. Note that, the TA corresponds to a standby time recited in claims.

Incidentally, in the present embodiment, the generation instruction section 23 of the control section 19 gives the frame generation instruction after the modulation section 15 receives the modulation instruction. Thus, a time at which the frame generation instruction based on the modulation instruction is given deviates from a time at which the modulation instruction is given so that the deviation is longer than the clock cycle by a factor of K₁ (K₁ is a constant natural number). Further, the deviation (hereinafter, referred to as a TB time) is constant in the present example. Thus, after the modulation instruction is given from the modulation instruction section 22, the generation instruction section 23 gives the instruction to generate the frame when a time calculated by adding the TA time and the TB time to each other passes. Note that, the time is referred to as a frame generation starting time. That is, generation of the frame is started at the same time as the frame generation instruction is given. Note that, as described above, the method for giving the frame generation instruction is merely an example. Even when other method is adopted, this does not influence the timestamp transmission jitter.

Further, as described above, when the frame generation section 14 receives the frame generation instruction, the frame generation section 14 acquires the time information of the timer 13 so as to incorporate the time information into the timestamp data as a frame. The acquisition of the time information is carried out when a time which is longer than the clock cycle by a factor of K₂ (K₂ is a constant natural number: hereinafter, the time is referred to as a TC time) passes after receiving the frame generation instruction. Further, frames each of which includes at least the timestamp data have the same formats, and a position of a bit storing the timestamp data is determined in each frame. Note that, it is preferable that TC is constant. In case of the IEEE802.11 standard, when the same transmission rate is set in the modulation section 15 every time, the TC is constant in view of a standard.

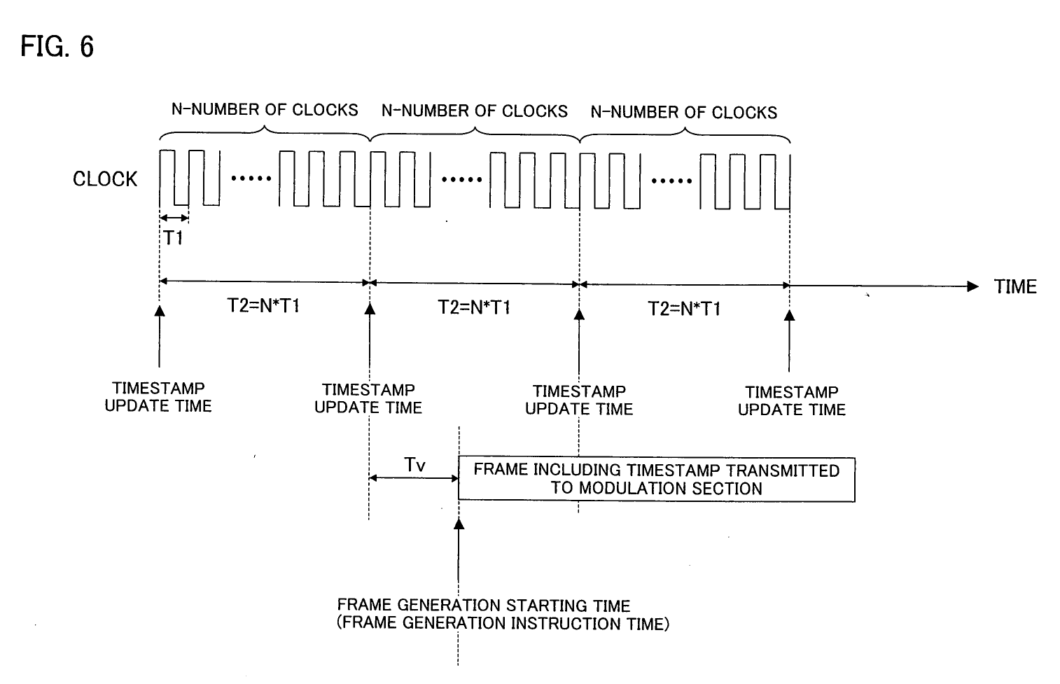

Here, as illustrated in FIG. 6, the time adjustment section 24 of the control section 19 adjust the TA so as to set a frame generation starting time (i.e., a time at which transmission of the frame to the modulation section 15 is started in the present embodiment) when a time which is longer than the clock cycle by a factor of K₃ (K₃ is a constant natural number) (this time is constant and corresponds to Tv in FIG. 6) passes after the timestamp update time just before the frame generation starting time (hereinafter, this timestamp update time is referred to as a just-before timestamp update time).

Further, the Tu is constant, so that also Tv+Tu is constant. Further, also the TC is constant. Thus, when the frame generation starting time is set in the foregoing manner, two arbitrary frames including the timestamp data are as follows.

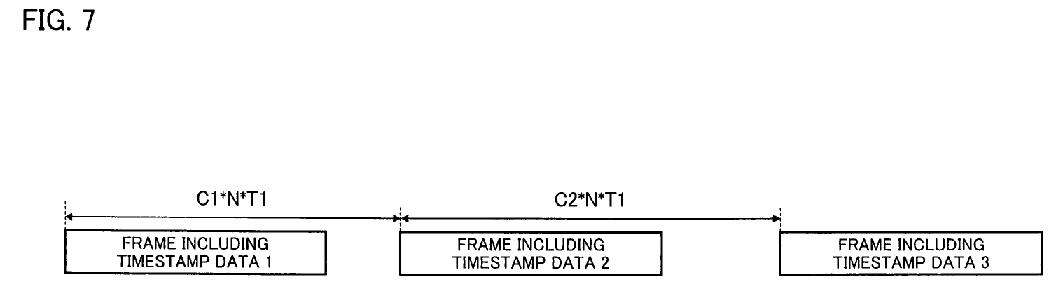

That is, as to sequential frames and two arbitrary frames, a difference between times at which the frames are outputted from the modulation section 15 to the communications path R (hereinafter, each of the times is referred to as an output starting time) is Ci×N×T1, and also a difference between times each of which is indicated by each timestamp data of each frame is Ci×N×T1 (Ci is a natural number determined for each combination of frames). FIG. 7 illustrates a condition under which each frame including each timestamp data is outputted to the communications path R in case where the TA is controlled.

Thus, the demodulation section 16 processes a frame transmitted from other communications apparatus, so that it is possible to always keep the aforementioned relationship even in case where it is impossible to transmit the frame including the timestamp data.

Specifically, for example, the TA is set to be a period from a time at which the CCA signal becomes into an OFF level state to a timestamp update time just after the foregoing time. Further, the arrangement is not limited to this, but it may be so arranged that: the TA is set to be a period from a time at which the CCA signal becomes into an OFF level state to a time calculated by adding a time longer than the clock cycle by a factor of a predetermined number to a timestamp update time just after the foregoing time.

As described above, a difference between a time at which the modulation section 15 is instructed to transmit the frame including the timestamp data and the timestamp update time just before the foregoing time (just-before timestamp update time) is constant, so that it is theoretically possible to vanish the timestamp transmission jitter of clock cycle×(N−1) which conventionally occurs. Further, a new frame format is not required, so that it is possible to keep compatibility with respect to a conventional system.

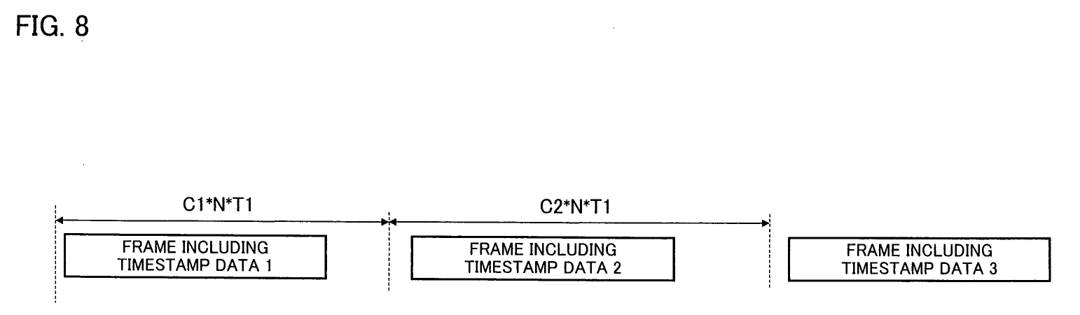

However, in the modulation section 15, a time taken for an RF (Radio Frequency) section (not shown) to carry out a process may vary. Further, an interval of the clock signals may deviate from a predetermined interval due to unstable oscillation of an oscillation circuit which generates the clock signals. Further, a clock signal used in the frame generation section 14 and a clock signal used in the modulation section 15 are respectively generated by different oscillation circuits, so that a difference occurs between a time at which the frame generated in the frame generation section 14 is inputted to the modulation section 15 and a time at which the frame comes to be processed. FIG. 8 illustrates a condition under which each frame including each timestamp data is outputted to the communications path R in this case.

For the foregoing reasons, it is impossible to completely vanish the timestamp transmission jitter actually.

However, as to two arbitrary frames, when a difference between (i) a difference of times at which the respective frames are transmitted from the modulation section 15 to the communications path R (first difference) and (ii) a difference of times each of which is indicated by each timestamp data included in each frame (second difference) is regarded as a sample, a value obtained by dividing a standard deviation of the sample by the predetermined cycle can be less than 0.1443376 in the communications apparatus 1.

Further, also in case where a difference between a time at which the frame comes to be transmitted to other communications apparatus and a time at which the time information included in the frame is updated is defined as a sample, a value obtained by dividing a standard deviation of the sample by the predetermined cycle can be less than 0.1443376 likewise.

Further, on the assumption that a jitter occurring between the communications apparatus and other communications apparatus is half of the predetermined cycle and distribution of timestamp transmission jitters is uniform, the standard deviation of the difference is 0.1443376 of the predetermined cycle.

How this relationship holds is detailed as follows.

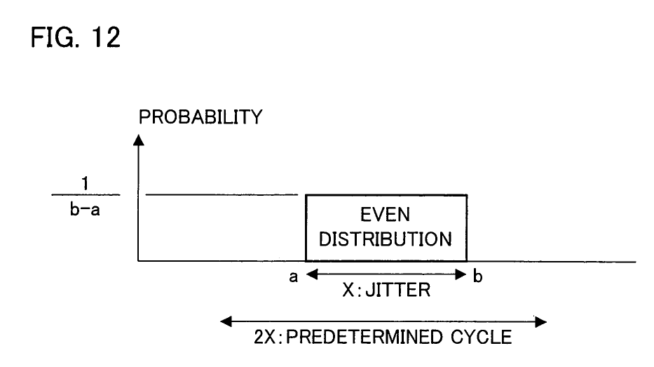

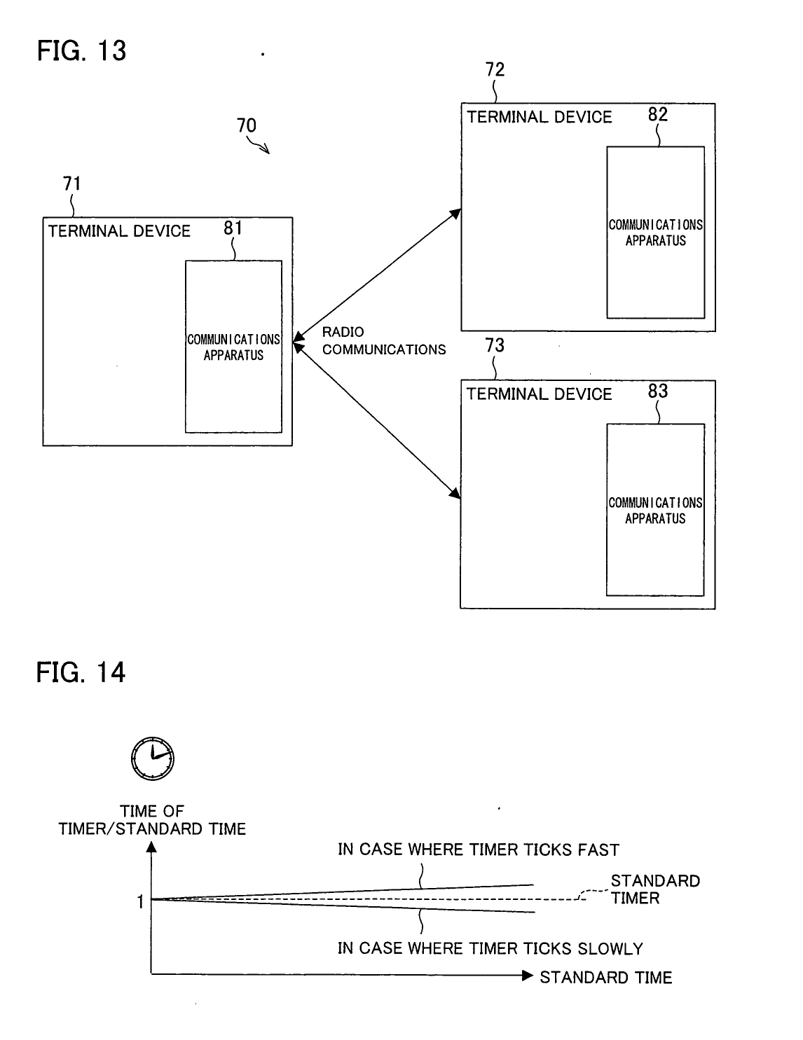

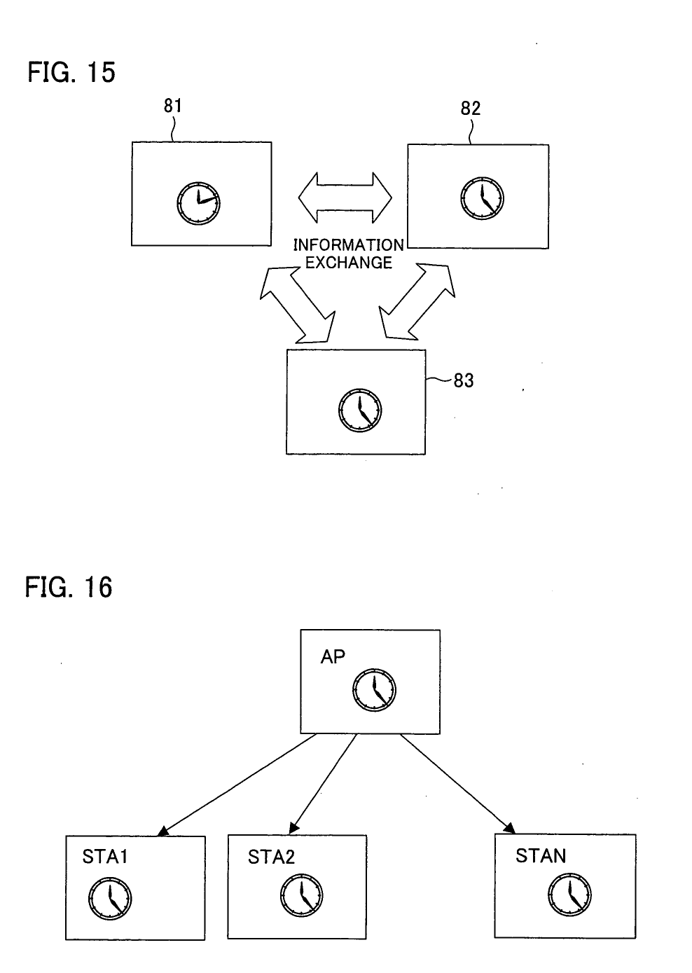

First, X of FIG. 12 is a timestamp transmission jitter and 2X is a predetermined cycle. The timestamp transmission jitter ranges from a to b. In this case, a standard deviation of a uniform distribution is expressed by the following equation.
Standard deviation of uniform distribution=(b−a)/(2√3)=X/(2√3)
Here, when the equation is divided by the predetermined cycle (2X), a standard deviation of the difference is 0.1443376 of the predetermined cycle as expressed by the following equation.
Standard deviation of uniform distribution/2X=X/(2√3)/2X=1/(4√3)=0.1443376

Incidentally, it is general that the communications apparatus 1 is installed onto one chip of a semiconductor LSI (Large Scale Integration), so that it is impossible to analyze a hardware structure in which the communications apparatus 1 of the LSI is installed and software included therein. However, it is possible to monitor the frame information from an input/output terminal of the LSI, so that it is possible to confirm the aforementioned condition under which (standard deviation of the sample)/(timestamp accuracy=1 μs)<0.1443376.

Further, as to two arbitrary frames, when a difference between (i) a difference of times at which the respective frames are transmitted from the modulation section 15 to the communications path R (first difference) and (ii) a difference of times each of which is indicated by each timestamp data included in each frame (second difference) is regarded as a sample, a value obtained by dividing a variance of the sample by the predetermined cycle can be less than ⅙ in the communications apparatus 1.

Further, on the assumption that a jitter occurring between the communications apparatus and other communications apparatus is half of the predetermined cycle and distribution of timestamp transmission jitters is uniform, the variance of the difference is ⅙ of the predetermined cycle.

Further, it is possible to monitor the frame information from an input/output terminal of the LSI, so that it is possible to confirm the aforementioned condition under which (variance of the sample)/(timestamp accuracy=1 μs)<⅙.

### EXAMPLE

The following explains a case where the communications apparatus 1 can be used in wireless LAN which is in compliance with the IEEE802.11 standard.

In this case, the clock signal generation section 11, the clock signal generation section 12, the timer 13, the frame generation section 14, the frame analysis section 17, the synchronization section 18, and the control section 19 correspond to a MAC (Media Access Control) layer. Further, the modulation section 15 and the demodulation section 16 correspond to a physical layer.

Further, the timestamp data is included in the beacon frame (hereinafter, referred to as a beacon). That is, an ordinary data frame includes no timestamp data. Hereinafter, the following explanation is given on the assumption that the frame generation section 14 generates not only the data frame but also the beacon. Hereinafter, the aforementioned processes required to be carried out by the control section 19 in generation of the frame including the timestamp data or in a similar process are carried out in generating the beacon. Note that, also the beacon corresponds to the frame recited in claims.

Further, in the foregoing standard, the T2 is 1 μs, and a beacon cycle (TBTT (Target Beacon Transmission Time)) is approximately 100 ms.

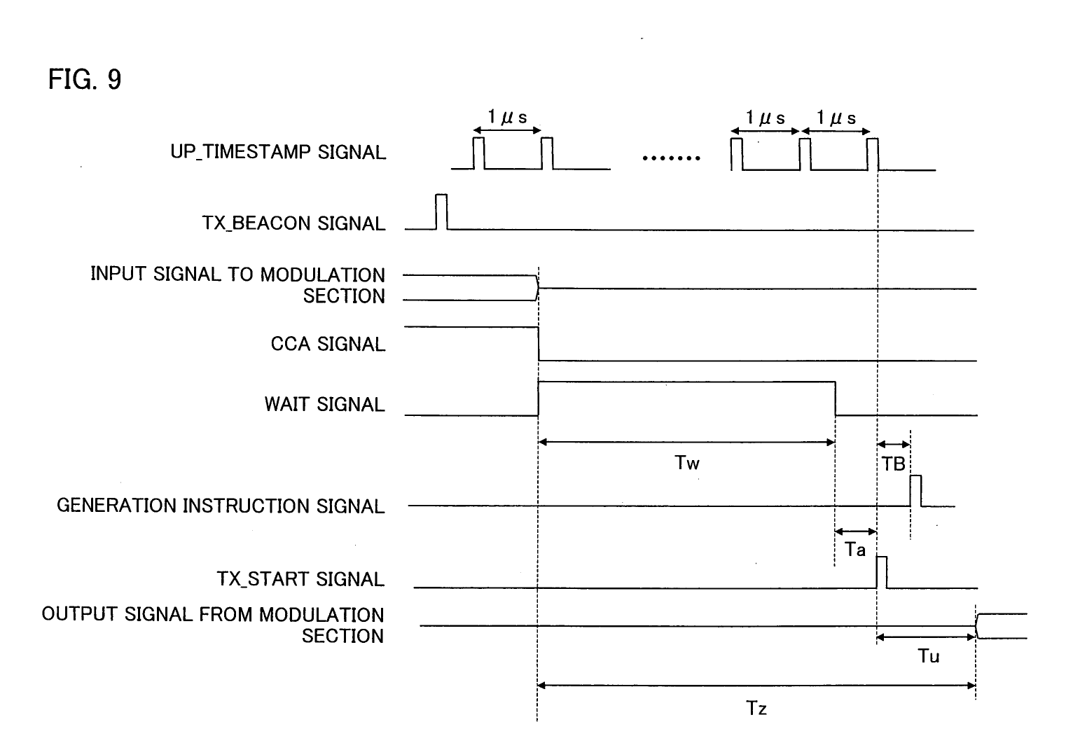

The control section 19 generates a TX_BEACON signal therein. Further, as illustrated in FIG. 9, the TX_BEACON signal is a pulse wave which is ordinarily in an OFF level state and becomes into an ON level state at a predetermined timing. Further, a time at which the TX_BEACON signal switches from the OFF level state into the ON level state is a time at which a beacon generation instruction should be given to the frame generation section 102.

Further, as illustrated in FIG. 9, the control section 19 generates a WAIT signal and a TX_START signal therein. Further, the TX_START signal is generated by the modulation instruction section 22 of the control section 19. Further, the modulation instruction section 22 transmits the TX_START signal to the modulation section 103. Note that, the WAIT is a level signal and the TX_START signal is a pulse wave. A case where the WAIT signal is in an ON level state and a case where the TX_START signal is in an ON level state will be described later. The TX_START signal in the ON level state corresponds to the modulation instruction.

Further, as described above, the control section 19 receives from the timer 13 a signal (UP_TIMESTAMP signal) which indicates as a pulse wave that the time information has been updated. Note that, as illustrated in FIG. 9, a time indicated by the updated time information corresponds to a time at which the UP_TIMESTAMP signal is in the ON level state.

The demodulation section 16, as described above, generates the CCA signal therein and transmits the CCA signal to the control section 19. Further, the demodulation section 16 makes the CCA signal into the ON level state while the frame exists in the communications path R (that is, while the demodulation section 16 is receiving the frame). Further, the modulation instruction section 22 of the control section 19 cannot instruct the modulation section 15 to start the modulation of the beacon while the control section 19 is receiving the CCA signal in the ON level state.

Further, when the demodulation section 16 stops receiving the frame, the CCA signal in the ON level state is not transmitted to the control section 19, and the control section 19 keeps the WAIT signal in the ON level state therein over the Tw time (certain time).

Further, the WAIT signal becomes into the OFF level state when the Tw time passes. In the conventional arrangement, the TX_START signal is made into the ON level state at this time. However, in the present example, the modulation instruction section 22 of the control section 19 makes the TX_START signal into the ON level state when another Ta time further passes. Note that, FIG. 9 illustrates an example in which a time taken to obtain the UP_TIMESTAMP signal in the ON level state after the WAIT signal becomes into the OFF level state is set as the Ta.

Further, the Ta is not limited to this time, and the Ta may be a time calculated by further adding a certain time to the time taken to obtain the UP_TIMESTAMP signal in the ON level state after the WAIT signal becomes into the OFF level state. Note that, the TX_START signal in the ON level state corresponds to a transmission instruction signal recited in claims.

Further, the modulated beacon is outputted to the communications path R when the Tu time passes. Thus, the modulated beacon is outputted to the communications path R when a time indicated by Tw+Ta+Tu (=Tz) passes after the CCA signal becomes into the OFF level state. Further, Tw+Ta corresponds to the TA.

Incidentally, in the IEEE802.11 standard, it is necessary to set the Tz (i.e., PIFS) within a range of 25±0.9 μs. Here, Ta is a variable time which can be varied within a range of 0≦Ta<T2. Thus, a maximum value which can be set as the Tw is 25.9 μs−(upper limit of Ta (=1 μs))−Tu=24.9 μs−Tu, and a minimum value which can be set as the Tw is 24.1+(minimum value of Ta (=0))−Tu=24.1−Tu. Thus, in case where an arbitrary value between the maximum value and the minimum value is set as the Tw, the Tz can be set within a range of 25±0.9 μs even when the Ta is varied within the foregoing range.

Note that, the TX_START signal causes the modulation section 15 to start the modulation. The frame data is actually given to the modulation section 15 when the TX_START signal becomes into the OFF level state again and a certain time passes. This period varies depending on implementation of the modulation section. Thus, the control section 19 has to transmit the beacon generation instruction to the frame generation section 102 by a time at which the control section 19 starts to give the data to the modulation section 15.

Here, the timing at which the frame generation instruction is given does not influence the timestamp transmission jitter. Further, a period in which it is possible to give the frame generation instruction is relatively long, so that the implementation method widely varies. Thus, the timing at which the frame generation instruction is given is out of the scope of the present invention. However, in the present example, the explanation is given on the assumption that the control section 19 gives the instruction after giving the modulation instruction to start the modulation. Note that, this will be detailed later.

Further, the control section 19 instructs the frame generation section 14 to generate the frame when the Ta time passes and the aforementioned TB time passes. Note that, the Ta is adjusted by the time adjustment section 24. Note that, 24.1 μs and 25.9 μs respectively correspond to the first time and the second time that are recited in claims.

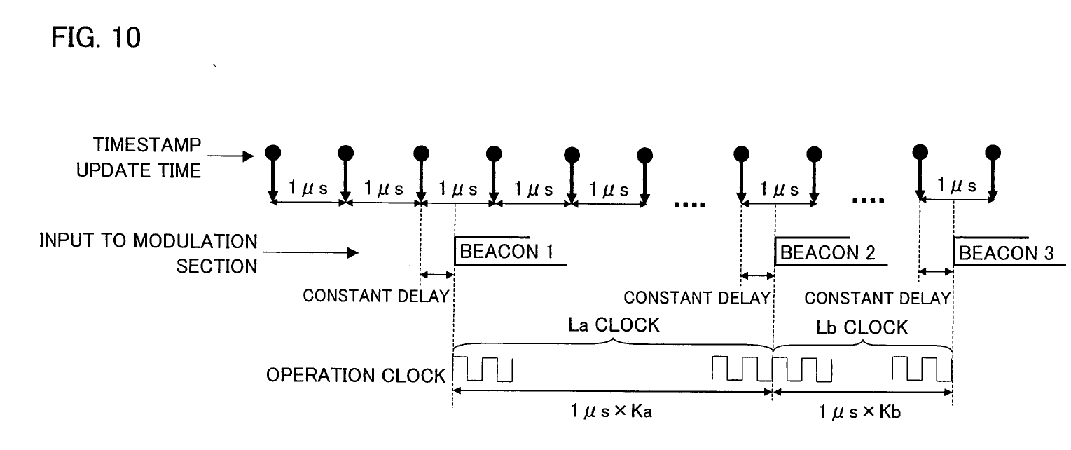

As described above, in the present example, based on such characteristic that the PIFS has a certain width, the Ta is varied (in other words, the TA is changed) for each beacon so as to set a beacon modulation instruction starting time (that is, in the present embodiment, a time at which transmission of the beacon to the modulation section 15 is started) to be a time when a time longer than the clock cycle by a factor of K₃ passes after the timestamp update time just before the beacon modulation starting instruction time (just-before timestamp update time). That is, as illustrated in FIG. 10, any beacons have the same value as a difference between a time at which each beacon comes to be inputted to the modulation section 15 and a timestamp update time just before the foregoing time.

On this account, as to sequential beacons and two arbitrary beacons, a difference between times at which the respective beacons are outputted from the modulation section 15 to the communications path R (output starting time) is Ci×N×T1, and also a difference between times each of which is indicated by each timestamp data included in each beacon is Ci×N×T1.

The demodulation section 16 processes a frame transmitted from other communications apparatus, so that this relationship is always kept even when it is impossible to transmit the frame including the timestamp data.

Specifically, for example, the Ta is set as a period from a time at which the CCA signal becomes into the OFF level state to a timestamp update time just after the foregoing time. Further, the arrangement is not limited to this, but it may be so arranged that: the Ta is set as a period from a time at which the CCA signal becomes into an OFF level state to a time calculated by adding a time longer than the clock cycle by a factor of a predetermined number to a timestamp update time just after the foregoing time.

As described above, a difference between a time at which the beacon including the timestamp data comes to be inputted to the modulation section 15 and the timestamp update time just before the foregoing time (just-before timestamp update time) is constant, so that it is logically possible to vanish the timestamp transmission jitter of clock cycle×(N−1) which conventionally occurs.

However, as described above, it is impossible to completely vanish the timestamp transmission jitter actually, so that a timestamp transmission jitter having a slight value occurs. However, the timestamp transmission jitter is extremely small, so that it is possible to reduce a jitter which results from the timestamp transmission jitter.

Specifically, in case of the conventional arrangement in which the receiving end communications apparatus causes the PLL circuit to adjust the timer, the communications apparatus 1 of the present example is used as the transmitting end apparatus. As a result, when at least five seconds passes since the transmission of the first beacon, it is possible to reduce a subsequent jitter to approximately 100 ns.

Thus, compared with the conventional arrangement, it is possible to achieve the desired jitter in extremely short time.

Further, it is not necessary to carry out variation of a frame format of the beacon or a similar process, it is possible to keep the compatibility with respect to the conventional system.

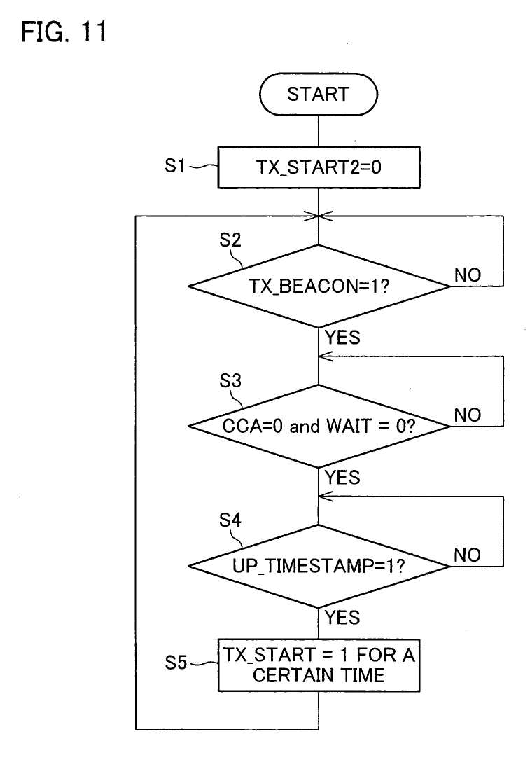

Next, with reference to FIG. 11, the following explains how the control section 19 carries out processes until the TX_START signal becomes into the ON level state as illustrated in FIG. 9. Note that, in FIG. 11, the ON level state of each signal is 1 and the OFF level state of each signal is 0.

First, the control section 19 makes the TX_START signal into the OFF level state (S1). After carrying out the step S1, the control section 19 determines whether the TX_BEACON signal is in the ON level state or not (S2). In case where it is determined that the TX_BEACON signal is not in the ON level state in S2, the process returns to S2. While, in case where it is determined that the TX_BEACON signal is in the ON level state in S2, the control section 19 determines whether or not the CCA signal is in the OFF level state and the WAIT signal is in the OFF level state (S3).

Further, when it is determined that at least one of both the signals is in the ON level state in S3, the process returns to S3. While, when it is determined that both the signals are in the OFF level state in S3, the control section 19 refrains from making the TX_START signal into the ON level state for the Ta time (S4). Further, after carrying out the step S4, the TX_START signal is made into the ON level state, and then the TX_START signal is made into the OFF level state (S5). Further, after carrying out the step S5, the process returns to S2. In this manner, a series of the steps is completed.

Incidentally, in the foregoing embodiment, at least the respective sections (11, 12, 14 to 17) operate in accordance with the same clock signal generated by the clock signal generation section 11. That is, as illustrated in FIG. 1, the timestamp update time corresponds to a time at which a pulse of the clock signal in the control section 19 rises. In this case, an instruction to transmit the frame is given when the time longer than the clock signal by a factor of K₃ passes after the time information is updated. Note that, K₃ corresponds to n2 (n2 is a constant natural number) recited in claims.

However, the arrangement is not limited to this, and it may be so arranged that: the timer 13, the frame generation section 14, and the control section 19 respectively operate in accordance with clock signals respectively generated by different clock signal generation sections.

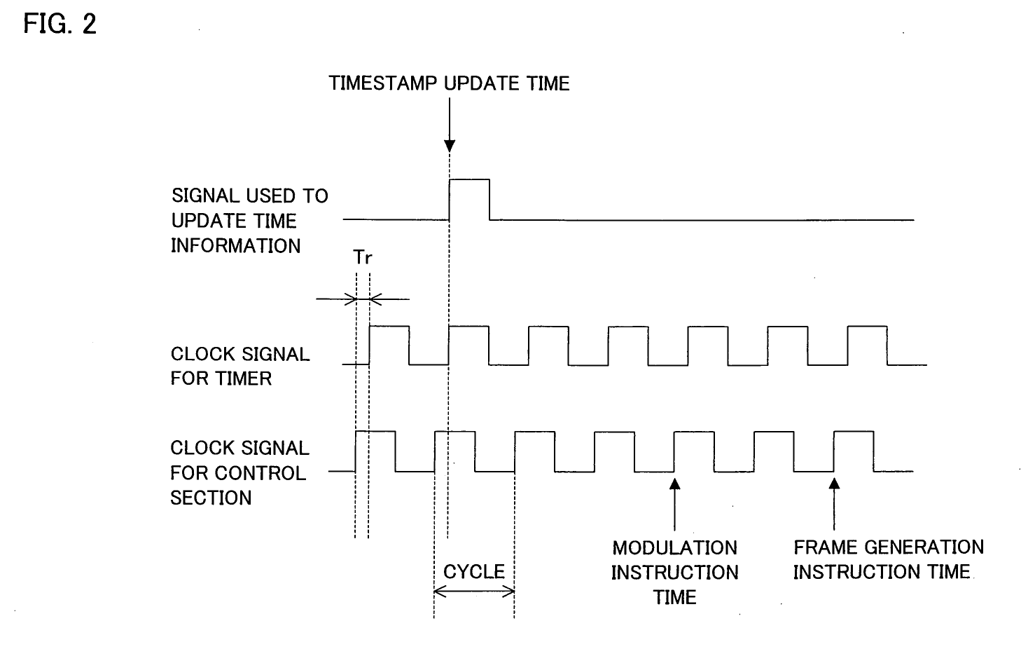

See FIG. 2. In the case where the timer 13, the frame generation section 14, and the control section 19 respectively operate in accordance with clock signals respectively generated by different clock signal generation sections, even when both the clock signals are identical with each other in a cycle, a time at which a pulse of one clock signal rises and a time at which a pulse of the other clock signal rises may be incompletely identical with each other and may have a slight deviation (Tr) therebetween. In the case where the time at which the pulse of one clock signal rises and the time at which the pulse of the other clock signal rises are slightly different from each other, the timestamp update time is not identical with the time at which the pulse of each clock signal rises.

Thus, in this case, if a time at which the time information is updated just before giving the frame transmission instruction is defined as a just-before-transmission-instruction time, the modulation instruction section 22 of the control section 19 gives the instruction to transmit the frame when a time longer than the clock signal by a factor of K₃ passes after either a starting time of the cycle of the clock signal including the just-before-transmission-instruction time or a starting time of a cycle subsequent to the cycle of the signal including the just-before-transmission-instruction time. Note that, the K₃ corresponds to n3 (n3 is a constant natural number) recited in claims.

Alternatively, the modulation instruction section 22 gives the instruction to transmit the frame when a time longer than the clock signal by a factor of K₃ passes after one of both the times which is approximate to the just-before-transmission-instruction time.

Further, even in case where both the clock signals are different from each other in a cycle, the same arrangement is adoptable.

Note that, in the IEEE802.11 standard, in order to equalize the difference between the times at which two beacons are transmitted from the modulation section 15 with the difference between the times each of which is indicated by the timestamp data included in each beacon, the transmission time at which the beacon is transmitted from the frame generation section 14 to the modulation section 15 and the processing time taken to output the beacon to the communications path R after the beacon is inputted to the modulation section 15 have to be constant. That is, a transmission rate in the physical layer has to be constant.

Further, the terminal device includes the communications apparatus 1 therein, so that it is possible to use a function of the communications apparatus 1 in the terminal device. Examples of an apparatus which is suitable as the terminal device include: a surround system such as a home theater; an AP terminal of wireless LAN; motion picture reproduction apparatus such as a DVD (Digital Versatile Disk) player, a DVD recorder, an HDD recorder, and the like; and broadcast receiving apparatuses such as a BS/CS tuner and the like.

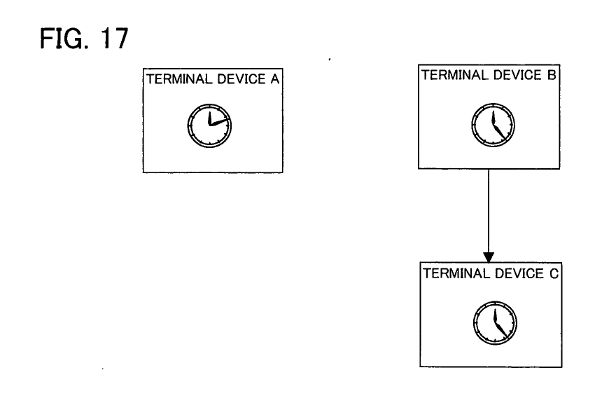

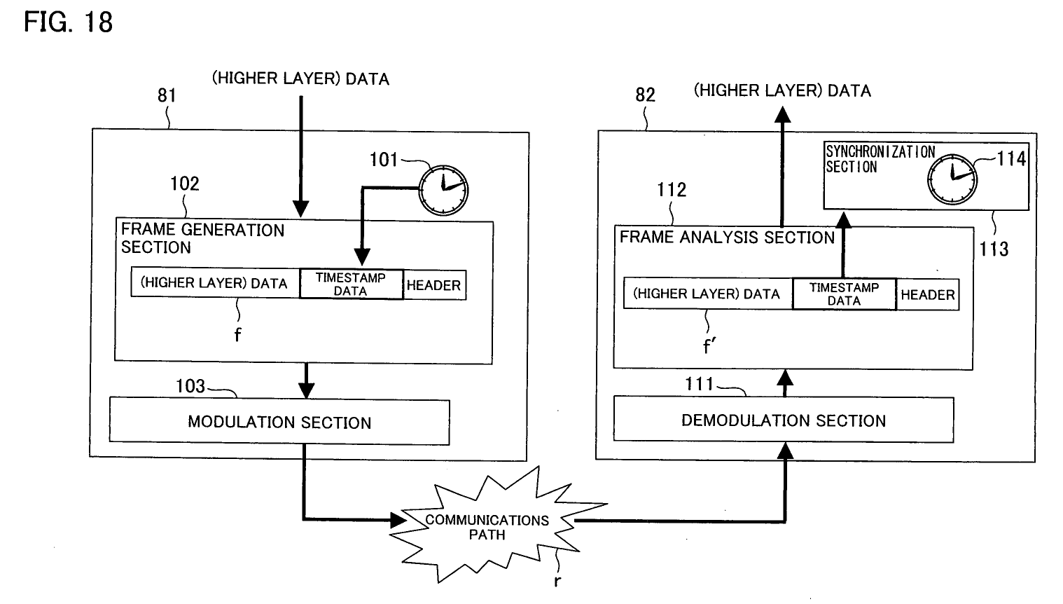

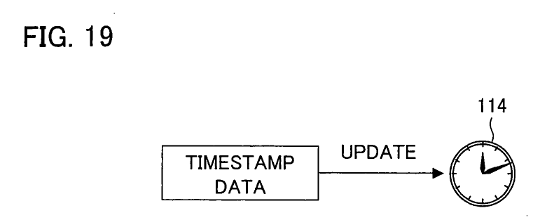

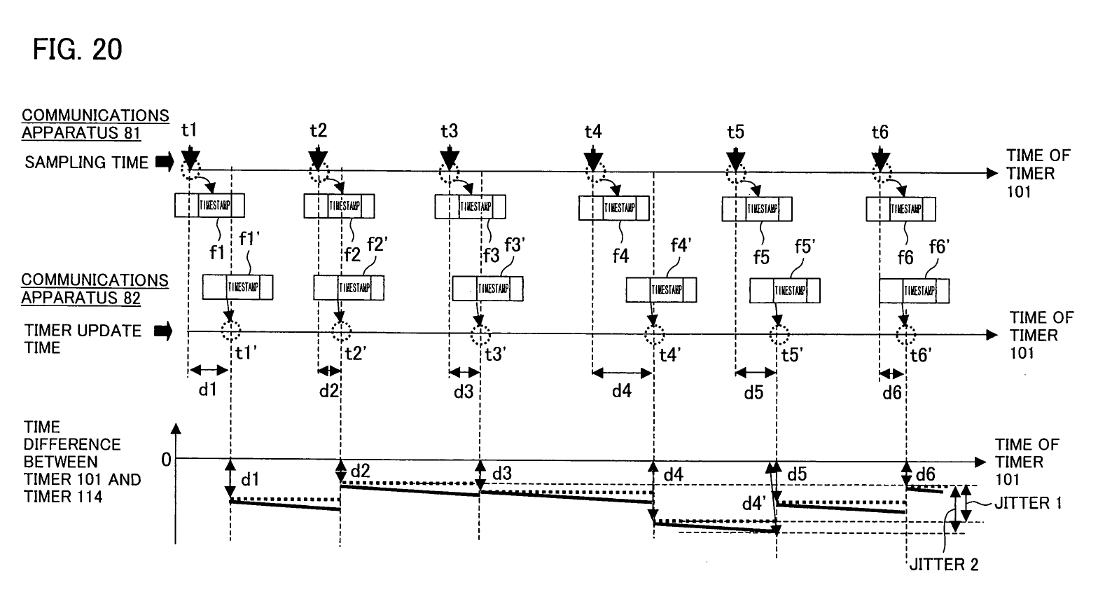

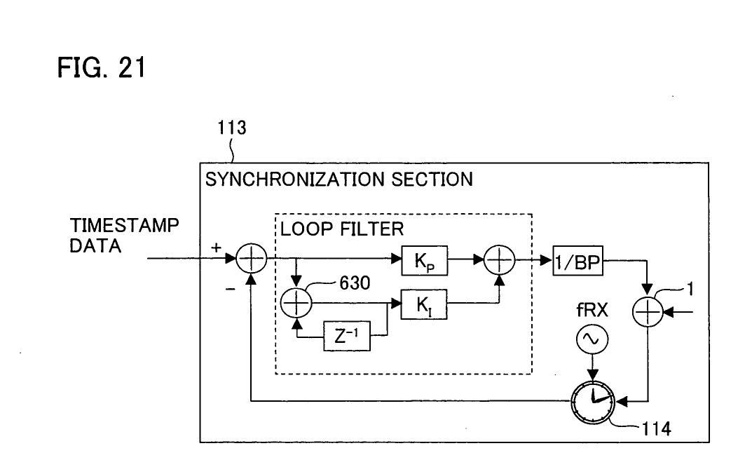

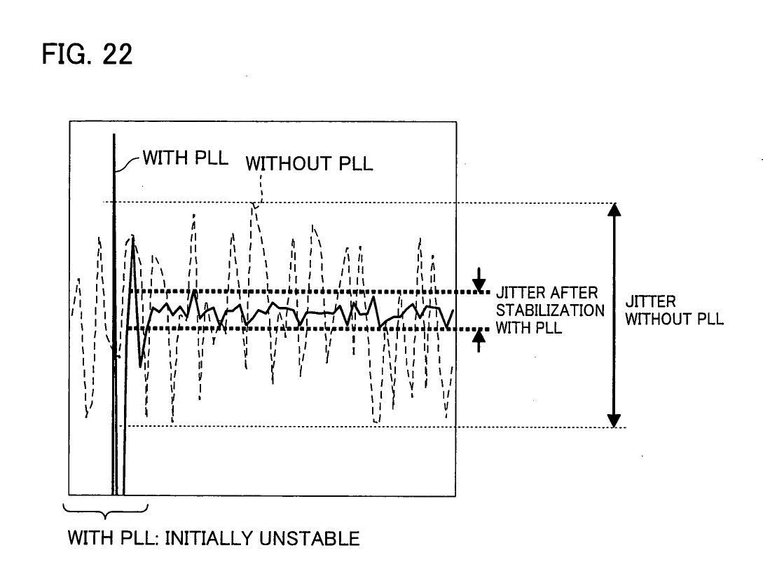

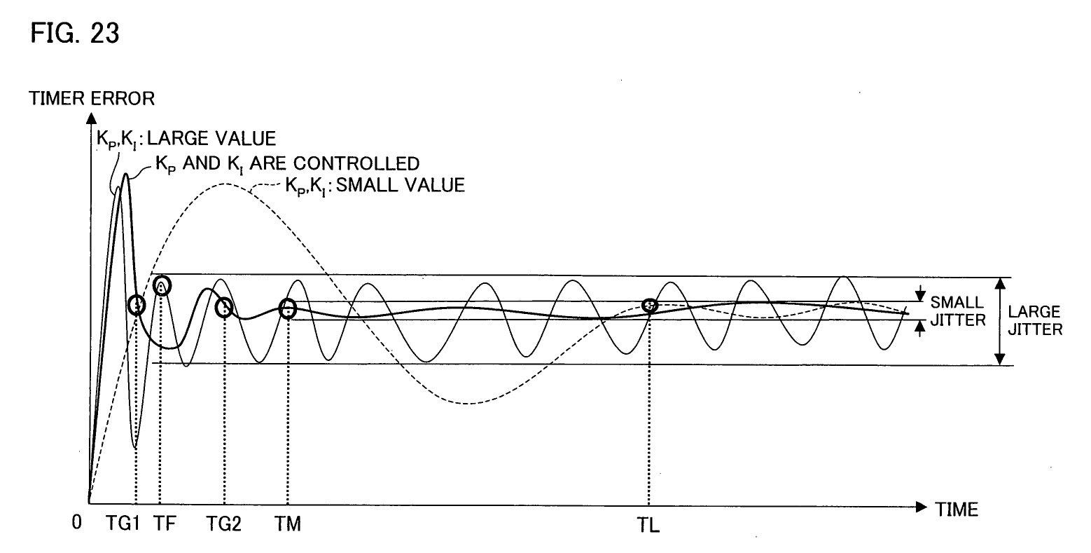

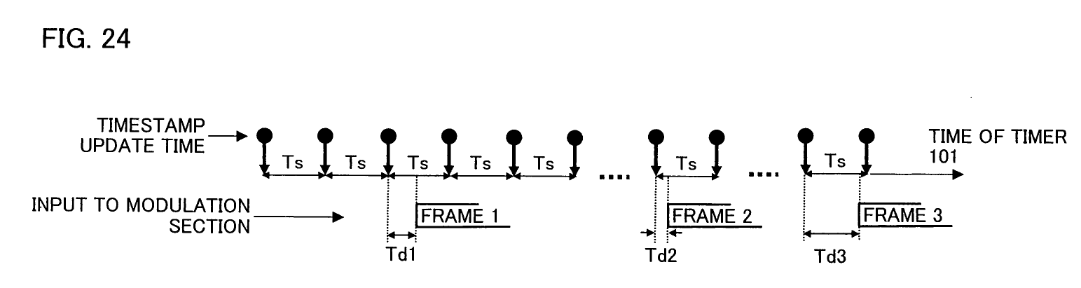

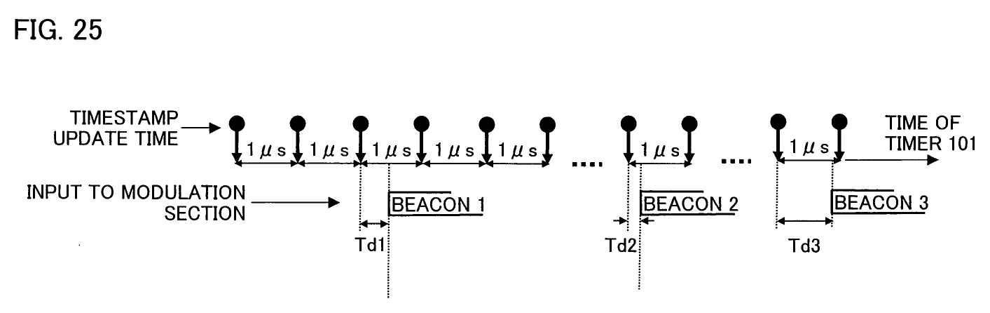

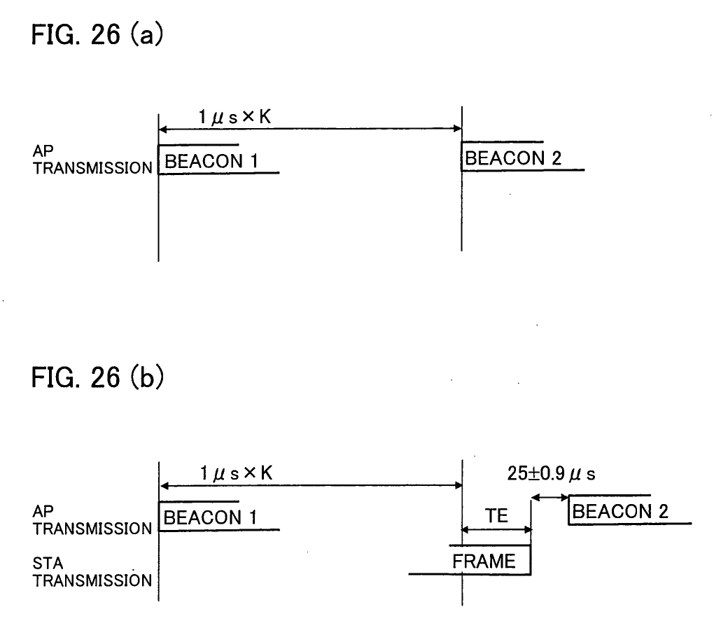

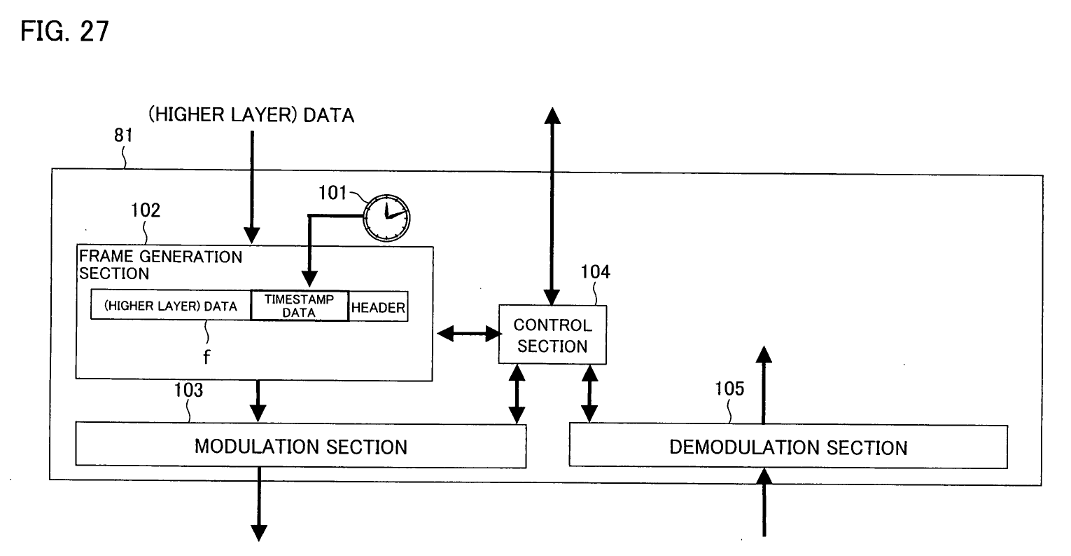

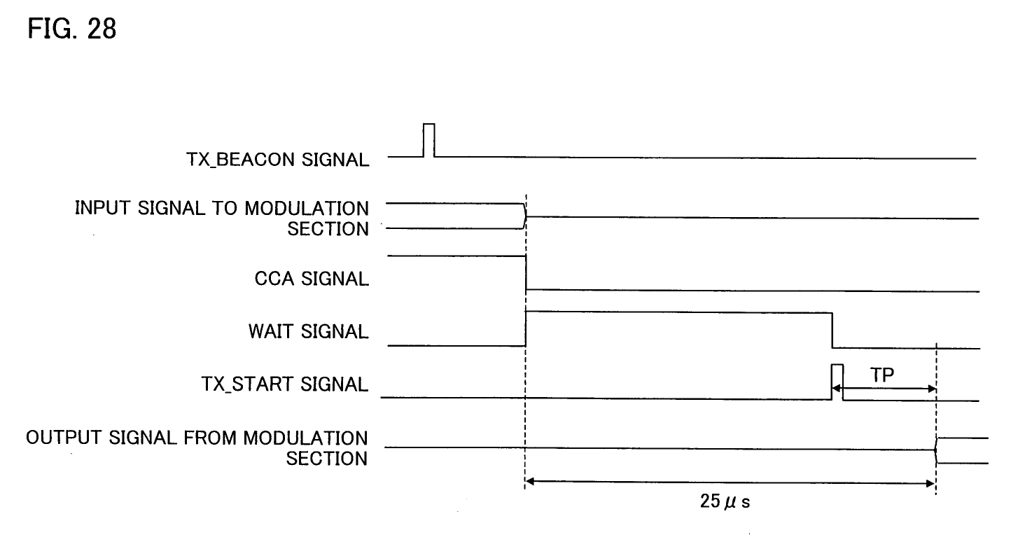

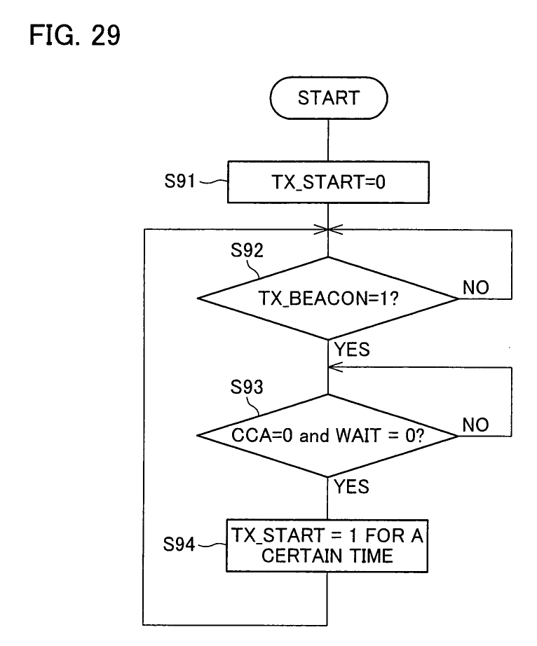

Further, the communications apparatus 1 is provided with the synchronization section 18, but the synchronization section 18 is not necessarily required. The synchronization section 18 is required only in case where the method illustrated in FIG. 17 is adopted as the method for adjusting the timer and the communications apparatus 1 receives data requiring the synchronization from other communications apparatus. For example, in the IEEE802.11 standard in which the beacon is targeted like the present example, the AP includes the timer 13 and includes neither the synchronization section 18 nor the timer 31, and the STA includes no timer 13 and includes both the synchronization 18 and the timer 31.

Further, the TX_BEACON signal may be generated at a certain cycle, or the TX_BEACON signal may be generated when a certain time passes after the frame including the timestamp data is outputted from the modulation section.

The present invention is not limited to the aforementioned embodiment and may be varied in many ways within the scope of claims. That is, also an embodiment obtained by combining technical means suitably varied within the scope of claims is included in the technical scope of the present invention.

Note that, the sections in the control section 19 of the communications apparatus 1 of the aforementioned embodiment and the steps carried out in the control section 19 of the communications apparatus 1 of the aforementioned embodiment can be realized by causing calculation means such as a CPU to execute a program stored in storage means such as ROM (Read Only Memory) and RAM and controlling inputting means such as a keyboard, outputting means such as a display, or communications means such as an interface circuit. Thus, a computer including these means reads out the program from the storage medium, and executes the program. Merely by carrying out this operation, it is possible to realize various kinds of functions and various kinds of processes in the communications apparatus of the present embodiment. Further, the program is stored in a removable storage medium, so that it is possible to realize the various kinds of functions and the various kinds of processes in an arbitrary computer.

As the storage medium, a memory (not shown) for allowing a microcomputer to carry out the processes, for example, a program medium such as ROM may be used, or it is possible to use a readable program medium provided with a program reading device (not shown) as an external storage device so that the storage medium is inserted into the program reading device so that the program is read therefrom.

Further, in any case, it is preferable that the stored program is accessed and executed by a microprocessor. Further, it is preferable to adopt a format in which: the program is read out, and the read program is downloaded into a program storage area of the microcomputer, and the program is executed. Note that, a downloading program is stored in a main body device in advance.

Further, the program medium is a storage medium which is detachable from the main body device, and examples thereof include: a tape, such as a magnetism tape and a cassette tape; a magnetism disk, such as a flexible disk and a hard disk; a disc, such as a CD/MO/MD/DVD; a card, such as an IC card (inclusive of a memory card); and a semiconductor memory, such as a mask ROM, an EPROM (erasable programmable read only memory), an EEPROM (electrically erasable programmable read only memory), or a flash ROM. All these storage media holds a program in a fixed manner.

In addition, if the system is configured to be connectible to a communications network, such as the Internet, it is preferred that the storage medium contains the program in a flowing manner like downloading the program over the communications network.

Further, to download the program over the communications network, it is preferred if the program for download is stored in the main body device in advance or installed from another storage medium.

A communications apparatus according to the present invention includes: signal generation means for generating a signal having a certain cycle; time update means for updating time information at a predetermined cycle longer than the certain cycle by a factor of n1 (n1>1 is a constant natural number); frame generation means for obtaining the time information so as to generate frames each of which includes the time information; transmission means for sequentially transmitting the frames, generated by the frame generation means, to other communications apparatus; and control means for instructing the transmission means to transmit the frames to said other communications apparatus, wherein: the frame generation means sequentially transmits to the transmission means the frames that have been generated, and the control means instructs the transmission means to transmit the frames when a time longer than the cycle of the signal by a factor of n2 (n2 is a constant natural number) passes after the time information is updated.

Further, the communications apparatus according to the present invention is arranged so that the control means includes: generation instruction means for instructing the frame generation means to generate the frames; and instruction signal generation means for generating a transmission instruction signal by which the transmission means is instructed to transmit the frames.

According to the foregoing arrangement, the instruction signal generation means can generate the transmission instruction signal by which the transmission means is instructed to transmit the frames to said other communications apparatus. Further, the generation instruction means can instruct the frame generation means to generate the frames in accordance with the transmission instruction signal.

Further, the communications apparatus according to the present invention is arranged so that: the control means further includes determination means for determining whether a frame transmitted from said other communications apparatus is being received or not, and in case where the determination means determines that the frame is being received, the instruction signal generation means stops generation of the transmission instruction signal.

According to the foregoing arrangement, the determination means can determine whether the frame transmitted from other communications apparatus is being received or not. Further, in case where it is determined that the frame is being received, the instruction signal generation means can stop generation of the transmission instruction signal.

Thus, while the frame is being received, the communications apparatus itself can stop transmission of the frame.

Further, the communications apparatus according to the present invention is arranged so that the control means further includes adjustment means for adjusting a period from a time at which the determination means determines that reception of the frame is finished to a time at which the transmission instruction signal is generated.

According to the foregoing arrangement, the adjustment means can adjust a period from the time at which the determination means determines that reception of the frame is finished to the time at which the transmission instruction signal is generated.

Therefore, it is possible to control the timing at which the transmission instruction signal is generated.

Thus, it is possible to control the timing of the instruction.

Further, the communications apparatus according to the present invention is arranged so that: when a certain time is required as a period from the generation of the transmission instruction signal to the transmission of the frame, in case where a period from a time at which the determination means determines that the reception of the frame is finished to a time at which the transmission instruction signal is generated is a standby time, the adjustment means adjusts the standby time so that a time at which the standby time and the certain time pass after the time at which the determination means determines that the reception of the frame is finished is a time at which a first time passes and a second time does not pass after the time at which the determination means determines that the reception of the frame is finished.

According to the foregoing arrangement, even in case where a certain time is required as a period from the time at which the transmission instruction signal is generated to a time at which the subsequent frame is transmitted, the adjustment means adjusts the standby time so that a time at which the standby time and the certain time pass after the time at which the determination means determines that the reception of the frame is finished is a time at which a first time passes and a second time does not pass after the time at which the determination means determines that the reception of the frame is finished.

Thus, it is possible to adopt the present communications apparatus also in a communications standard in which a frame subsequent to the received frame is transmitted when the first time passes and the second time does not pass after determining that reception of the latter frame is finished.

Further, the communications apparatus according to the present invention is arranged so that: each of the signal generation means, the time update means, the frame generation means, and the control means is a MAC layer which is in compliance with IEEE802.11 standard, and the transmission means is a physical layer which is in compliance with the IEEE802.11 standard.

According to the foregoing arrangement, each of the signal generation means, the time update means, the frame generation means, and the control means is a MAC layer which is in compliance with IEEE802.11 standard, and the transmission means is a physical layer which is in compliance with the IEEE802.11 standard.

Thus, the present communications apparatus can be used as an apparatus which is in compliance with the IEEE802.11 standard.

Further, the communications apparatus according to the present invention is arranged so that includes a MAC layer which is in compliance with IEEE802.11 standard, wherein in case where a beacon frame generated in the MAC layer is not transmitted to said other communications apparatus at a TBTT time and a transmission rate of the beacon frame is constant, the value obtained by dividing the standard deviation of the sample by the predetermined cycle is less than 0.1443376.

According to the foregoing arrangement, in the IEEE802.11 standard, it is possible to reduce the timestamp transmission jitter to a value which substantially realizes the foregoing jitter even when it is impossible to transmit the beacon frame at a predetermined timing.

Further, the communications apparatus according to the present invention serves as an access point of wireless LAN.

According to the foregoing arrangement, it is possible to provide a communications apparatus, serving as an access point of wireless LAN, which can reduce the timestamp transmission jitter compared with the conventionally occurring timestamp jitter.

In order to solve the foregoing problems, a program according to the present invention causes a computer to function as the respective means of the communications apparatus.

Thus, it is possible to provide the communications apparatus to a user by loading the program to a computer system.

In order to solve the foregoing problems, a storage medium according to the present invention is a computer-readable storage medium storing the program.

Thus, it is possible to provide the communications apparatus to a user by loading the program stored in the storage medium to a computer system.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

The present invention can reduce the timestamp transmission jitter, so that the present invention is applicable to a communications apparatus which has to carry out data communications requiring small jitter and to various communications devices such as a terminal device including the communications apparatus or similar devices.

What is claimed is:

1. A communications apparatus, comprising:
a signal generation section for generating a signal having a certain cycle;
a time update section for updating time information at a predetermined cycle longer than the certain cycle by a factor of n1 (n1>1 is a constant natural number);
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
the control section instructs the transmission section to transmit the frames when a time longer than the cycle of the signal by a factor of n2 (n2 is a constant natural number) passes after the time information is updated.

2. The communications apparatus as set forth in claim 1, wherein
the control section includes:
a generation instruction section for instructing the frame generation section to generate the frames; and
an instruction signal generation section for generating a transmission instruction signal by which the transmission section is instructed to transmit the frames.

3. The communications apparatus as set forth in claim 2, wherein:
the control section further includes a determination section for determining whether a frame transmitted from said other communications apparatus is being received or not, and
in case where the determination section determines that the frame is being received, the instruction signal generation section stops generation of the transmission instruction signal.

4. The communications apparatus as set forth in claim 3, wherein the control section further includes an adjustment section for adjusting a period from a time at which the determination section determines that reception of the frame is finished to a time at which the transmission instruction signal is generated.

5. The communications apparatus as set forth in claim 4, wherein:
when a certain time is required as a period from the generation of the transmission instruction signal to the transmission of the frame,
in case where a period from a time at which the determination section determines that the reception of the frame is finished to a time at which the transmission instruction signal is generated is a standby time,
the adjustment section adjusts the standby time so that a time at which the standby time and the certain time pass after the time at which the determination section determines that the reception of the frame is finished is a time at which a first time passes and a second time does not pass after the time at which the determination section determines that the reception of the frame is finished.

6. The communications apparatus as set forth in claim 1, wherein:
each of the signal generation section, the time update section, the frame generation section, and the control section is a MAC layer which is in compliance with IEEE802.11 standard, and
the transmission section is a physical layer which is in compliance with the IEEE802.11 standard.

7. The communications apparatus as set forth in claim 1, serving as an access point of wireless LAN.

8. A communications apparatus, comprising:
a signal generation section for generating a signal having a certain cycle;
a time update section for updating time information at a predetermined cycle longer than the certain cycle;
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time.

9. The communications apparatus as set forth in claim 8, wherein
the control section includes:
a generation instruction section for instructing the frame generation section to generate the frames; and
an instruction signal generation section for generating a transmission instruction signal by which the transmission section is instructed to transmit the frames.

10. The communications apparatus as set forth in claim 9, wherein:
the control section further includes a determination section for determining whether a frame transmitted from said other communications apparatus is being received or not, and
in case where the determination section determines that the frame is being received, the instruction signal generation section stops generation of the transmission instruction signal.

11. The communications apparatus as set forth in claim 10, wherein the control section further includes an adjustment section for adjusting a period from a time at which the determination section determines that reception of the frame is finished to a time at which the transmission instruction signal is generated.

12. The communications apparatus as set forth in claim 11, wherein:
when a certain time is required as a period from the generation of the transmission instruction signal to the transmission of the frame,
in case where a period from a time at which the determination section determines that the reception of the frame is finished to a time at which the transmission instruction signal is generated is a standby time,
the adjustment section adjusts the standby time so that a time at which the standby time and the certain time pass after the time at which the determination section determines that the reception of the frame is finished is a time at which a first time passes and a second time does not pass after the time at which the determination section determines that the reception of the frame is finished.

13. The communications apparatus as set forth in claim 8, wherein:
each of the signal generation section, the time update section, the frame generation section, and the control section is a MAC layer which is in compliance with IEEE802.11 standard, and
the transmission section is a physical layer which is in compliance with the IEEE802.11 standard.

14. The communications apparatus as set forth in claim 8, serving as an access point of wireless LAN.

15. A communications apparatus, transmitting frames each of which includes timestamp information to other communications apparatus, said timestamp information being obtained by sampling time information updated at a predetermined cycle, wherein
in case where two arbitrary frames out of the frames are first and second frames, and
a difference between a time indicated by timestamp information included in the first frame and a time indicated by timestamp information included in the second frame is a first difference, and
a difference between a time at which the first frame comes to be transmitted to said other communications apparatus and a time at which the second frame comes to be transmitted to said other communications apparatus is a second difference, and
a difference between the first difference and the second difference is regarded as a sample,
a value obtained by dividing a standard deviation of the sample by the predetermined cycle is less than 0.1443376.

16. The communications apparatus as set forth in claim 15, comprising a MAC layer which is in compliance with IEEE802.11 standard, wherein
in case where a beacon frame generated in the MAC layer is not transmitted to said other communications apparatus at a TBTT time and a transmission rate of the beacon frame is constant, the value obtained by dividing the standard deviation of the sample by the predetermined cycle is less than 0.1443376.

17. The communications apparatus as set forth in claim 15, serving as an access point of wireless LAN.

18. A communications apparatus, transmitting frames each of which includes timestamp information to other communications apparatus, said timestamp information being obtained by sampling time information updated at a predetermined cycle, wherein
in case where a difference between a time at which the frames come to be transmitted to said other communications apparatus and a time at which the timestamp information included in each of the frames is regarded as a sample,
a value obtained by dividing a standard deviation of the sample by the predetermined cycle is less than 0.1443376.

19. The communications apparatus as set forth in claim 18, comprising a MAC layer which is in compliance with IEEE802.11 standard, wherein
in case where a beacon frame generated in the MAC layer is not transmitted to said other communications apparatus at a TBTT time and a transmission rate of the beacon frame is constant, the value obtained by dividing the standard deviation of the sample by the predetermined cycle is less than 0.1443376.

20. The communications apparatus as set forth in claim 18, serving as an access point of wireless LAN.

21. A communications method in which a transmission section instructed to transmit frames transmits frames generated by a frame generation section to other communications apparatus,
said communications method comprising:
a signal generation step in which a signal having a certain cycle is generated;
a time update step in which time information is updated at a cycle longer than the certain cycle by a factor of n1 (n1>1 is a constant natural number);
an instruction step in which the transmission section is instructed to transmit the frames when a time longer than the cycle of the signal by a factor of n2 (n2 is a constant natural number) passes after the time information is updated;
a frame generation step in which the time information is obtained so that each frame including the time information is generated; and
a transmission step in which the frames generated by the frame generation section are sequentially received and the frames are sequentially transmitted to said other communications apparatus.

22. A communications method in which a transmission section instructed to transmit frames transmits frames generated by a frame generation section to other communications apparatus,
said communications method comprising:
a signal generation step in which a signal having a certain cycle is generated;
a time update step in which time information is updated at a cycle longer than the certain cycle;
an instruction step in which, in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time;
a frame generation step in which the time information is obtained so that each frame including the time information is generated; and
a transmission step in which the frames generated by the frame generation section are sequentially received and the frames are sequentially transmitted to said other communications apparatus.

23. A program, causing a computer to function as sections of a communications apparatus including:
a signal generation section for generating a signal having a certain cycle;
a time update section for updating time information at a predetermined cycle longer than the certain cycle by a factor of n1 (n1>1 is a constant natural number);
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
the control section instructs the transmission section to transmit the frames when a time longer than the cycle of the signal by a factor of n2 (n2 is a constant natural number) passes after the time information is updated.

24. A program, causing a computer to function as sections of a communications apparatus including:
a signal generation section for generating a signal having a certain cycle;
a time update section for updating time information at a predetermined cycle longer than the certain cycle;
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time.

25. A program, causing a computer to function as sections of a communications apparatus which transmits frames each of which includes timestamp information to other communications apparatus, said timestamp information being obtained by sampling time information updated at a predetermined cycle, wherein
in case where two arbitrary frames out of the frames are first and second frames, and
a difference between a time indicated by timestamp information included in the first frame and a time indicated by timestamp information included in the second frame is a first difference, and
a difference between a time at which the first frame comes to be transmitted to said other communications apparatus and a time at which the second frame comes to be transmitted to said other communications apparatus is a second difference, and
a difference between the first difference and the second difference is regarded as a sample,
a value obtained by dividing a standard deviation of the sample by the predetermined cycle is less than 0.1443376.

26. A program, causing a computer to function as sections of a communications apparatus which transmits frames each of which includes timestamp information to other communications apparatus, said timestamp information being obtained by sampling time information updated at a predetermined cycle, wherein
in case where a difference between a time at which the frames come to be transmitted to said other communications apparatus and a time at which the timestamp information included in each of the frames is regarded as a sample,
a value obtained by dividing a standard deviation of the sample by the predetermined cycle is less than 0.1443376.

27. A computer-readable storage medium, storing a program which causes a computer to function as sections of a communications apparatus including:
a signal generation section for generating a signal having a certain cycle;
a time update section for updating time information at a predetermined cycle longer than the certain cycle by a factor of n1 (n1>1 is a constant natural number);
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
the control section instructs the transmission section to transmit the frames when a time longer than the cycle of the signal by a factor of n2 (n2 is a constant natural number) passes after the time information is updated.

28. A computer-readable storage medium, storing a program which causes a computer to function as sections of a communications apparatus including:
a signal generation section for generating a signal having a certain cycle;
a time update section for updating time information at a predetermined cycle longer than the certain cycle;
a frame generation section for obtaining the time information so as to generate frames each of which includes the time information;
a transmission section for sequentially transmitting the frames, generated by the frame generation section, to other communications apparatus; and
a control section for instructing the transmission section to transmit the frames to said other communications apparatus, wherein:
the frame generation section sequentially transmits to the transmission section the frames that have been generated, and
in case where a time at which the time information is updated just before instructing the transmission section to transmit the frames is a just-before-transmission-instruction time, the control section instructs the transmission section to transmit the frames when a time longer than the cycle of the signal by a factor of n3 (n3 is a constant natural number) passes, after one of (i) a starting time of the cycle of the signal including the just-before-transmission-instruction time and (ii) a starting time of a cycle subsequent to the cycle of the signal including the just-before-transmission-instruction time, or after one of both the starting times which is approximate to the just-before-transmission-instruction time.

29. A computer-readable storage medium, storing a program which causes a computer to function as sections of a communications apparatus which transmits frames each of which includes timestamp information to other communications apparatus, said timestamp information being obtained by sampling time information updated at a predetermined cycle, wherein
in case where two arbitrary frames out of the frames are first and second frames, and
a difference between a time indicated by timestamp information included in the first frame and a time indicated by timestamp information included in the second frame is a first difference, and
a difference between a time at which the first frame comes to be transmitted to said other communications apparatus and a time at which the second frame comes to be transmitted to said other communications apparatus is a second difference, and
a difference between the first difference and the second difference is regarded as a sample,
a value obtained by dividing a standard deviation of the sample by the predetermined cycle is less than 0.1443376.

30. A computer-readable storage medium, storing a program which causes a computer to function as sections of a communications apparatus which transmits frames each of which includes timestamp information to other communications apparatus, said timestamp information being obtained by sampling time information updated at a predetermined cycle, wherein
in case where a difference between a time at which the frames come to be transmitted to said other communications apparatus and a time at which the timestamp information included in each of the frames is regarded as a sample,
a value obtained by dividing a standard deviation of the sample by the predetermined cycle is less than 0.1443376.
